(19) United States
(12) Patent Application Publication
(10) Pub. No.: US 2026/0099257 A1
(43) Pub. Date: Apr. 9, 2026

(54) SECOND CHANCE FOR END-OF-LIFE FLASH MEMORY BLOCKS VIA PAGE ISOLATION

(71) Applicant: UNIVERSITY OF VIRGINIA PATENT FOUNDATION, Charlottesville, VA (US)

(72) Inventors: Mircea Stan, Charlottesville, VA (US); Muhammed Ceylan Morgul, Charlottesville, VA (US)

(21) Appl. No.: 19/349,609

(22) Filed: Oct. 3, 2025

Related U.S. Application Data
(60) Provisional application No. 63/703,853, filed on Oct. 4, 2024.

(51) Int. Cl. G06F 3/06

(52) U.S. Cl. CPC G06F 3/0616; G06F 3/0619; G06F 3/0659; G06F 3/0679

(57) ABSTRACT

A method for page isolation for memory blocks is provided herein. The method may include determining that a memory block of a set of memory blocks has achieved an end-of-life state, where the memory block may include a plurality of pages. The method may include, responsive to the memory block achieving the end-of-life state, executing page isolation with respect to the plurality of pages in order to increase lifetime of at least a subset of the plurality of pages.

### CROSS-REFERENCES TO RELATED APPLICATIONS

This application claims priority to U.S. Provisional Application No. 63/703,853, filed Oct. 4, 2024, the entire contents of which is incorporated herein by reference.

### STATEMENT OF GOVERNMENT SUPPORT

N/A

### BACKGROUND

This disclosure relates to flash memory, which is a type of non-volatile storage technology commonly used in devices such as USB drives, SSDs, and memory cards, allowing data to be retained even when power is removed. It operates by storing electrical charges in storage cells (e.g., floating-gate transistors or charge-trap transistors), which can be programmed and erased electronically. However, flash memory has inherent lifetime limitations due to the wear caused by repeated program/erase cycles, which gradually degrade the insulating oxide layer and lead to eventual data retention and reliability issues.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides a system. The system may include an electronic processor. The electronic processor may be configured to determine that a memory block of a set of memory blocks has achieved an end-of-life state, where the memory block may include a plurality of pages. The electronic processor may be configured to, responsive to the memory block achieving the end-of-life state, execute page isolation with respect to the plurality of pages in order to increase lifetime of at least a subset of the plurality of pages.

In some examples, the technology disclosed herein provides a method for page isolation for memory blocks. The method may include determining, with an electronic processor, that a memory block of a set of memory blocks has achieved an end-of-life state, where the memory block may include a plurality of pages. The method may include, responsive to the memory block achieving the end-of-life state, executing, with the electronic processor, page isolation with respect to the plurality of pages in order to increase lifetime of at least a subset of the plurality of pages.

In some examples, the technology disclosed herein provides a non-transitory computer-readable storage medium storing instructions that, when executed by a processor, cause the processor to perform a method of page isolation. The method may include determining that a memory block of a set of memory blocks has achieved an end-of-life state, where the memory block may include a plurality of pages. The method may include, responsive to the memory block achieving the end-of-life state, executing page isolation with respect to the plurality of pages in order to increase lifetime of at least a subset of the plurality of pages.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1A schematically illustrates example integrated circuits (ICs) according to some configurations.

FIG. 1B schematically illustrates an example SSD architecture according to some configurations.

FIG. 1C schematically illustrates a flash memory within a thermal insulation according to some configurations.

FIG. 2 schematically illustrates an example organization of an SSD, an example NAND flash memory block (array) structure, and NAND flash memory operations according to some configurations.

FIG. 3 illustrates an example erased cell according to some configurations.

FIG. 4 illustrates an example programmed cell 400 according to some configurations.

FIG. 5 illustrates an example trap-site generation according to some configurations.

FIG. 6 illustrates example trapping according to some configurations.

FIG. 7 illustrates example de-trapping and charge loss according to some configurations.

FIG. 8 illustrates example trap recovery according to some configurations.

FIGS. 9A-9B are example graphs illustrating example expected behavior according to some configurations.

FIG. 10 illustrates an example diagram of inference capacitors according to some configurations.

FIG. 11 illustrates an example implementation of a Page Isolation technique according to some configurations.

FIGS. 12A-12C illustrate example experimental schemes for comparison of page isolation methods and no-isolation at a given age according to some configurations.

FIG. 13A is an example graph of BER results for Page Isolation with regular stress cycling (with no-isolation during cycling) according to some configurations.

FIG. 13B is an example graph of BER results for Page Isolation with reduced stress cycling (with 1-page-isolation during cycling) according to some configurations.

FIG. 14 is an example graph illustrating a comparison between the proposed-regular Page Isolation and Page Isolation with dummy reads according to some configurations.

FIG. 15A is an example graph illustrating results with respect to time-zero errors according to some configurations.

FIG. 15B is an example graph illustrating results with respect to 3-minuets retention errors according to some configurations.

FIG. 16 is an example graph illustrating average program/erase cycling latency at around the given age according to some configurations.

FIG. 17 is an example graph illustrating a BER comparison of Page Isolation including data-1 pattern at 25° C. according to some configurations.

FIG. 18 is an example graph illustrating a 10-minute retention test and performance of Page Isolation at 95° C. according to some configurations.

FIG. 19 schematically illustrates an example memory architecture according to some configurations.

FIG. 20 is a flowchart illustrating an example method for implementing Page Isolation according to some configurations.

FIG. 21 schematically illustrates an example enhanced SSD simulator according to some configurations.

FIG. 22 is an example snippet of a sample SSD configuration file that shows reliability-related parameters according to some configurations.

FIG. 23 is an example snippet of a sample workload definition file according to some configurations.

FIG. 24 is an example graph illustrating the number of blocks in recovery at a given time while enabling Proactive Recovery and Page Isolation according to some configurations.

FIG. 25 illustrates an example of Level-1 page isolation equivalent for 3D NAND similar to 2D NAND according to some configurations.

FIG. 26 is an example graph illustrating 1-Sub-Block Isolation results according to some configurations.

FIG. 27 is an example diagram illustrating 1-page and 2-page isolations for 2D NAND according to some configurations.

FIG. 28 is an example diagram illustrating no page isolation for 3D NAND according to some configurations.

FIG. 29 is an example diagram illustrating isolating sub-blocks (1-sub-block isolation) according to some configurations.

FIG. 30 is an example diagram illustrating isolating 1-Layer-Neighbor according to some configurations.

FIG. 31 is an example diagram illustrating isolating 1-Layer-Neighbor and 1-SubBlock-Neighbor according to some configurations.

FIG. 32 is an example diagram illustrating isolating 1-Layer-Neighbor, 1-SubBlock-Neighbor and 1-Diagonal-Neighbor according to some configurations.

FIG. 33 is an example diagram illustrating 2-layer isolation according to some configurations.

FIG. 34 is an example diagram illustrating 2-layer isolation and 1-SubBlock-Neighbor isolation according to some configurations.

FIG. 35 is an example diagram illustrating 2-layer isolation 2-SubBlock-Neighbor isolation according to some configurations.

FIG. 36 is an example diagram illustrating 2-layer isolation and at least 1-SubBlock-Neighbor isolation according to some configurations.

FIG. 37 is an example diagram illustrating 2-layer isolation and at least 2-SubBlock-Neighbor isolation according to some configurations.

FIG. 38 is an example diagram illustrating 3-layer isolation according to some configurations.

FIG. 39 is an example diagram illustrating 3-layer isolation according to some configurations.

FIG. 40 is an example diagram illustrating 3-layer isolation according to some configurations.

FIG. 41 is an example diagram illustrating 3-layer isolation according to some configurations.

FIG. 42 is an example diagram illustrating 4-layer isolation according to some configurations.

FIG. 43 is an example diagram illustrating 4-layer isolation according to some configurations.

FIG. 44 is an example diagram illustrating 4-layer isolation according to some configurations.

FIG. 45 is an example block diagram illustrating an example of a machine according to some configurations.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts.

Flash memories are widely used in various applications due to their high density and non-volatility with the support of reliability techniques for known endurance (e.g., number of Program-Erase (P/E) cycles) limitation. These techniques include device-level recovery, such as self-healing and Proactive Recovery, or system-level mitigation, such as, e.g., over-provisioning, wear-leveling, or read-retry. The goal is to maintain data integrity at higher endurance levels. However, none of these techniques address flash blocks that have reached the uncorrectable error limit. Flash memories are widely preferred for their high bit density despite their relatively low endurance limitations. One of the dominant reasons for the low reliability of flash memory is cell-to-cell program interference during page operations. Programming a target cell also alters the threshold voltages of neighboring cells depending on the distance. These effects become more prominent as blocks age, resulting in blocks being abandoned after reaching their end of life due to unrecoverable errors.

Accordingly, the technology disclosed herein provides a Page Isolation technique that, rather than abandoning aged blocks, gives aged blocks a second (or multiple) chance. The technology disclosed herein proposes a Page Isolation technique to reuse some pages of aged blocks that are otherwise abandoned regardless of techniques used during the standard lifetime. The idea is to isolate some pages to enable others to continue to be used, reaching up to or more than 7.7× more endurance than the projected lifetime of those blocks. The technique may involve skipping every other page, word line, row, or layer (e.g., more pages for higher ages) in the process of declaring free page addresses after a garbage collection for the blocks that are reaching an uncorrectable error count. The simplicity of the technique allows for easy implementation in the Flash Translation Layer without increasing computational complexity. The Page isolation technique lowers penalty of capacity loss due to the retirement of the aged-blocks by enabling to use some pages of these blocks beyond their anticipated lifetime.

As described in greater detail herein, the Page Isolation technique may include isolating pages to mitigate cell-to-cell program interference, which may be considered the most dominant factor for the alteration of threshold voltage. When blocks age, factors are combined to increase the threshold voltage overlaps of the states, which causes exceeding the correctable error limit. The main reason for the alteration of the threshold voltage of the victim cell is the parasitic capacitive coupling, which is inversely proportional by distance. This means closer neighbors will have much more effect than the distanced neighbors. Therefore, in some configurations, the Page Isolation technique described herein starts isolating the pages by 1 page after reaching the uncorrectable error limit and increasing the number of isolating pages as needed. The technology disclosed herein may enable the use of 50% and 33% of the end-of-life block pages for 3.5× and at least 7.7× beyond their anticipated lifetime, respectively. Using two consecutive pages for isolation (2-Page-Isolation) does not lead to any error in the duration of our experiment. Therefore, it can be conclude that Page Isolation results in more than 7.7× lifetime improvement for some pages at some conditions, such as, e.g., 50° C.

Isolating the pages does not introduce any complex decisions during the implementation in the Flash Translation Layer (FTL) of the SSD. Statically skipping some pages of aged blocks during the declaration of free addresses may be sufficient. A simple modification in the firmware may be sufficient since “bad block management”, “garbage collection”, and “address translator” algorithms of the FTL may be in place and take care of all the processes.

As described herein, the technology disclosed herein may be complementary to other techniques. The technology disclosed herein may enable the use of page addresses otherwise retired (e.g., increases capacity). The technology disclosed herein does not introduce any complexity penalty.

The technology disclosed herein relates to an integrative approach to significantly enhance the endurance and sustainability of non-volatile memories, such as, e.g., flash memory and solid-state drives (SSDs). The technology disclosed herein aims to meet the specifications of emerging applications, including, e.g., processing in memory, remote Internet of Things (IoT) devices, data centers, etc., particularly for managing hot (e.g., frequently updated) data through the development and application of device- and system-level techniques, as described herein.

In some examples, operating flash memory in high-temperature environments may improve the time-zero error reliability and may extend endurance of the flash memory, which may suggest a pathway for processing intensive applications. In some configurations, a dual-temperature SSD architecture may be implemented that optimizes flash memory for both processing and storage, leveraging temperature differentials to maximize longevity.

Additionally, in some configurations, the technology disclosed herein may be implemented with proactive recovery (e.g., inspired by biological Circadian Rhythms), which may mitigate wear-out and extend memory lifespan to further improve sustainability and reliability. The technology described herein may be beneficial for applications involving high demand and durability, such as, e.g., data centers, as well as applications involving sustainable memory solutions, such as, e.g., remote IoT devices. The technology disclosed herein provides significant improvements in flash memory reliability and sustainability.

In some configurations, the technology disclosed herein may provide an advanced flash translation layer (FTL) model that integrates proactive recovery and page isolation techniques to enhance efficiency and endurance of SSD controllers. Testing the system-level implications of these integrated approaches has been conducted through simulation and benchmarking using the state-of-the-art SSD simulator MQSim, with a focus on reducing byte error rates, extending device longevity, and improving environmental sustainability.

The technology disclosed herein may allow for the application to other non-volatile memory technologies, such as, e.g., the ferroelectric capacitor, which is to be used as a memory element, to show its broadening impact. The outcomes may include a substantial extension of device endurance, environmental sustainability

### 1—Introduction

### 1.1—Reliability of Electronics

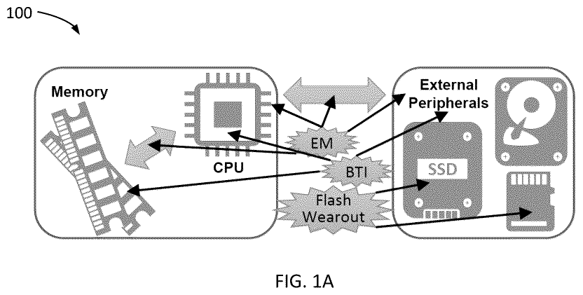

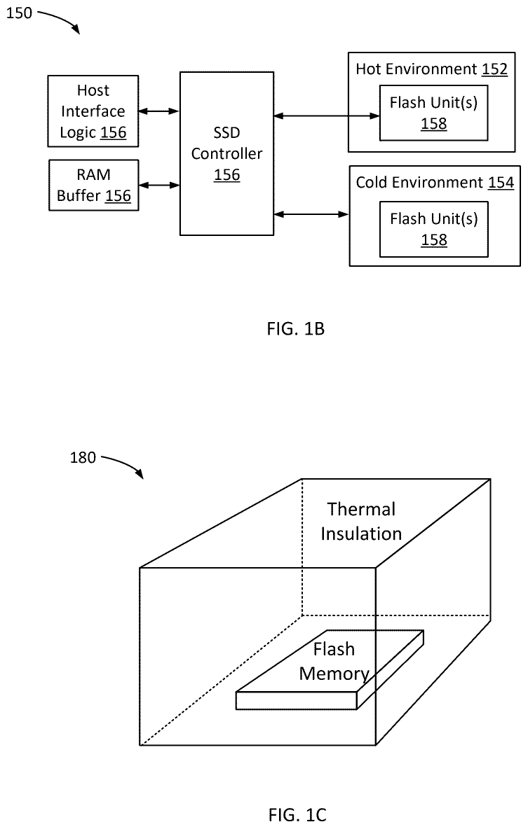

As semiconductor chips are widely adopted in mission- or safety-critical application domains, and as the scale of these chips increases dramatically with heterogeneous integration, there is a growing interest in extending the silicon lifetime. This is especially true in scenarios like automotive, data center, or medical devices. Even in consumer electronics, like cell phones, the cost of the design drives up the necessity of designing highly reliable chips that last longer. Chip aging, a device-level degradation mechanism, has been a major threat to silicon lifetime. It happens to all major parts of a computing system, such as computation and memory, where aging may be dominated by bias temperature instability (BTI), at interconnects, where aging may be dominated by electro-migration (EM), and storage, where aging may be dominated by flash wear out, etc., as illustrated in FIG. 1. FIG. 1 illustrates example integrated circuits (ICs) where investigated dominant aging phenomena, BTI, EM, and flash wear-out reside, in accordance with some examples. Aging mechanisms share similar physics fundamentally. As such, the concept of recovery can be adapted as a uniform way to combat aging more effectively.

Semiconductor technology scaling has introduced tremendous benefits in terms of better performance, lower power, and higher levels of integration. However, in advanced nodes with smaller feature sizes, on-chip components, such as, e.g., transistors, interconnects, or non-volatile memory devices (e.g., flash memory), become more susceptible to voltage stress due to the increased effective field with the scaling of the thin oxide. In addition, the shrinking geometries of metal interconnects result in higher current densities, which further accelerate the aging effects. From the application perspective, with the ubiquity of electronics in daily lives, there have been increasing demands for reliable system design. Examples include, e.g., automotive, industrial, or space applications, where the cost of failure may be extremely high. Many of such applications thus involve a much longer lifetime, higher utilization rate, tighter hard-error tolerances, etc. Due to various global factors, chip shortage has become a limiter for manufacturing (e.g., from cars to robotic vacuum cleaners).

### 1.1.1—Reliability of Non-Volatile Memories and Flash Memory

The reliability of memory or storage may be investigated differently than the reliability of a compute element, despite being explained with the same physical phenomena, such as, e.g., trap generation, hot carrier injection, bias temperature instability, stress-induced leakage current, etc. In the context of reliability studies concerning memory or storage, there emerges a issue: “data integrity,” which is as significant as “device integrity” if not more. The new reliability specifications, such as, e.g., the capability of storing data (e.g., endurance), duration of retaining data (e.g., retention), and resilience against disturbances (e.g., interference mitigation), have emerged.

Moreover, for device integrity investigations, a dominant stress at the oxide is seen as unidirectional for the compute/switching element; whereas the stress is bidirectional for the oxide of non-volatile memory.

### 1.2—Motivation and Awareness of Reliability Specifications of the Applications

As the integration of non-volatile memory technologies, such as, e.g., flash memory and SSDs, continues to proliferate across diverse sectors, the sustainability and reliability of non-volatile memory technologies in high-demand environments, such as, e.g., processing-in-memory (PiM), remote IoT devices, or data centers have become paramount. Such high-demand environments frequently involve handling rapidly updated data or the high cost of device replacement, involving advancements in memory technology that not only meet performance demands but also adhere to sustainability standards. For instance, the lifetime specifications are considered to be more than 20 years for applications associated with mission-critical, industrial, or automotive.

In the present disclosure, flash memory was selected to develop the application-aware reliability techniques for non-volatile memories because of the established characteristics of electronics. For instance, flash memory is used in more than 99% of various applications. The low cost per bit of flash memory, with acceptable power and performance, makes flash memory an integral part of the memory hierarchy. Moreover, the high bit density of flash memory makes flash memory a great candidate for in-memory computing (e.g., processing using-flash). Reliability techniques may be developed by considering the application-specific specifications.

In addition to system-level mitigation techniques, such as, e.g., overprovisioning (e.g., increasing spare capacity), wear-leveling (e.g., equalizing the stress throughout blocks), or read-retry (e.g., optimizing Read voltage), the self-healing capability of flash memories may be leveraged to improve device-level reliability. Recovery can be enabled by allowing the device to rest, which is called passive recovery. Recovery can be accelerated with temperature, which is called accelerated recovery. The trap recovery mechanism in flash memory varies with temperature and time. Thermal emission is highly temperature-dependent, while tunneling exhibits less sensitivity.

The analytical relation between lifetime and the passive recovery may be showed by representing the dwell-time (e.g., duration of one P/E cycle) as recovery time. Accelerated recovery may be implemented with temperature. Accelerated recovery may be spread in time. In some instances, implementations may perform dwell-time-aware, retention-time-aware, and data-aware recovery and wear-leveling techniques. However, such implementations may not fully meet the device-level reliability involved for specific applications, such as, e.g., PiM. Furthermore, the challenge of replacing aged or damaged devices in remote IoT applications underscores the need of more resilient memory solutions that can self-recover and cater to the unique needs of each application. Proactively leveraging the recovery time may help overcome such challenges.

### 1.3—Proactive Approach

### 1.3.1—Leveraging Temperature: High Temperature for Processing Intensive Applications

Reliability studies for processing-intensive applications, especially processing using memory. Since reliability studies for flash memories focus on storage applications, low temperatures are recommended. This is mainly because retention errors are predominant among other types of errors for a storage application. The results indicate that processing applications benefit from higher temperatures (e.g., increasing longevity by 2×), unlike storage applications.

For example, FIG. 1B schematically illustrates an example SSD architecture 150 according to some configurations. The SSD architecture 150 may include separate processing and storage units that allow separate changes to the respective environments. In the illustrated example, the SSD architecture 150 may include a hot environment as a separate processing unit (represented in FIG. 1B by reference numeral 152) and a cold environment 154 as a separate storage unit (represented in FIG. 1B by reference numeral 154). As illustrated in FIG. 1B, a SSD controller 156 may send data to flash units 158 that are in the hot environment 154 or the cold environment 156. As such, for data processing applications, the SSD controller 156 sends the data to flash units 158 in the hot environment 154. Conversely, for storage applications, the SSD controller 156 sends the data to the cold flash environment 152. In some examples, high-temperature processing can be scalable to Multi-LC flash as a decrease in BER during Program and Erase operations may be observed in 2D-MLC, 2D-TLC and 3D-MLC, and 3D-TLC NAND flash memories.

In order to efficiently obtain high temperatures, smart heating/cooling mechanisms may be implemented that transfer heat from one part of the system to another depending on the temperature specifications. The deployment of a thermal insulation package 180 in the proposed architecture can be one way to develop a smart heating/cooling mechanism, as illustrated in FIG. 1C. Flash memories dissipate heat as does every electronic system. If a practical thermal insulation package is built around the flash memory, the heat may dissipate by itself, and it will help to increase and retain its temperature.

Power dissipation of “20 P/E+1 Read” may be estimated as 2.4 W from datasheet values and time measurements. The ambient temperature of an electronic system may be assumed to be 35° C. The temperature of the flash may be targeted to be 95° C., and calculated thermal resistance of 24.8° C./W, assuming a material with a thermal resistivity of around 70 m° C./W is selected, and a derived area of 100 mm2 from a datasheet. Based on these assumptions, the thickness of the thermal insulation package 180 may be calculated to be ≈35 mm. This number is acceptable considering the form factor of an SSD, and it can be smaller in the case of parallel processing. Another option could be harvesting heat from other parts of the system.

### 1.3.2—Leveraging Time: Proactive Recovery

Proactive recovery may enhance the endurance and sustainability of non-volatile memories. The technology described herein has been proven effective against common degradation phenomena, such as, e.g., BTI and EM, offering a promising technical solution for extending the lifespan and reliability of memory systems in demanding and variable environments. Flash memory longevity can be increased by as much as 9 times.

### 1.3.3—Leveraging Existing Memory Structure: Page Isolation

One of the reasons for flash memory has low reliability is cell-to-cell program interference during page operations. Programming a target cell also alters the threshold voltages of neighboring cells depending on the distance. These effects become more prominent as blocks age, resulting in blocks being abandoned after reaching their end of life due to unrecoverable errors. The technology disclosed herein provides a page isolation technique to reuse some pages of aged blocks that are otherwise abandoned regardless of the techniques used during the standard lifetime. For instance, in some configurations, the technology disclosed herein may provide a page isolation technique that isolates some pages to enable other pages to continue to be used, which may reach more endurance than the projected lifetime of those blocks (e.g., between 6.2× and 7.7×). The page isolation technique may include skipping every other page (more pages for higher ages) in the process of declaring free page addresses after the garbage collection for the blocks that are reaching an uncorrectable error count. The simplicity of the page isolation technique allows for easy implementation in the FTL without increasing computational complexity.

### 1.4—System-Level Implementation and Implications

This disclosure describes testing the validity of Page Isolation techniques at the system (SSD) level. There are four steps to achieve this: 1) selecting a verified SSD simulator and enhancing its reliability assessment capabilities; 2) generating system-level reliability model parameters based on a verified device-level model; 3) implementing the reliability techniques at the FTL of the simulator; and 4) running the simulation. The system-level simulation demonstrates that: 1) “required additional blocks to keep the same capacity seen by the host when Proactive Recovery is used” that is only 0.25% and 2) “if Page Isolation is feasible” that is “yes.”

### 1.5—Outline and Contributions

This disclosure describes Page Isolation. Implementation of Page Isolation at the FTL and testing system-level implications are also described herein. Additionally, Page Isolation may be applicable for other non-volatile technologies.

The contributions of this work can be summarized as: (a) proactively developing solution for abandoning end-of-life blocks: Page Isolation; (b) enhanced FTL with Page Isolation; and (c) testing the FTL with application benchmarks, and development of reliability techniques.

### 2.1—SSD Organization, Flash Memory Structure and Operations

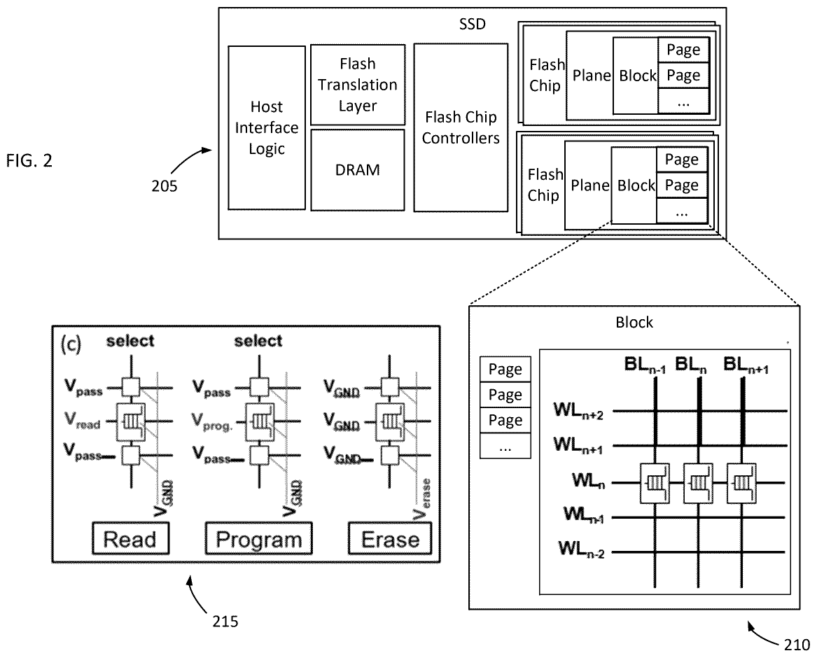

One of the most common applications of flash memory is in SSDs for storage. Due to technological and reliability restrictions, flash memory involves the assistance of the FTL and Flash Chip Controllers. FIG. 2 illustrates an example organization of an SSD (represented in FIG. 2 by reference numeral 205), an example NAND flash memory block (array) structure (represented in FIG. 2 by reference numeral 210), and NAND flash memory operations (represented in FIG. 2 by reference numeral 215). An SSD has multiple flash memory chips or dies; each die has multiple planes, and the planes consist of multiple blocks.

NAND flash memory blocks are arrays that consist of cells, such as, e.g., floating gate (FGT) or charge trap transistors (CTT). As illustrated in FIG. 2, in two-dimensional (2D) rows and columns are called word-lines (WLs) (or pages) and bit-lines (BLs), respectively. Cells are cascaded and serially connected in every column. On the other hand, gates of transistors that are placed in the same row share the word-line voltage. Three-dimensional (3D) NAND flash consists of layers, sub-blocks, WLs, and BLs. The goal of page isolation is to effectively isolate physical WLs.

Non-volatile flash memory cells store information with a threshold voltage value. The information is labeled to a Vth range (or state), not fixed values. For instance, data are stored as threshold voltage (Vₜₕ) ranges (or states), as opposed to fixed values. The read operation is performed by applying a Read-Reference Voltage (V_{read}) to the gate of the target transistor while applying a Pass-Voltage (Vₚₐₛₛ) to the gates of the remaining transistors in the same BL, as illustrated in FIG. 2, and subsequently sensing the current through the BL.

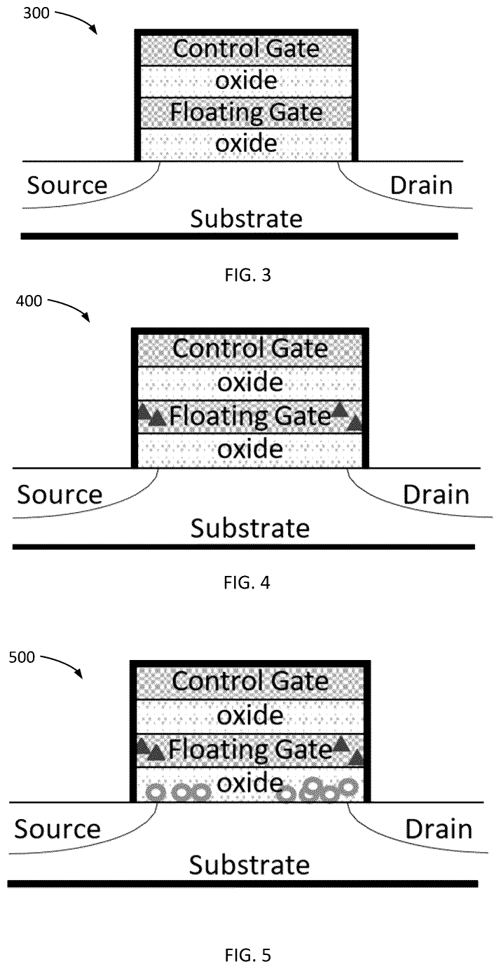

Program and erase operations change the states (or data) of cells through electron movements. During a Program operation, pulses of the Program-Voltage (V_{program}) are applied to a gate of the target cell to change the corresponding threshold voltage (Vₜₕ), while the Pass-Voltage (Vₚₐₛₛ) is applied to others in the same BL. Whereas in the Erase operation, the direction of the electric field is reversed by applying the Ground-Voltage (V_{GND}) to all WLs (gates of all cells) in the Block and the Erase-Voltage (Vₑᵣₐₛₑ) to the body of cells (e.g., substrate of the Block). FIG. 3 illustrates an example erased cell 300, in accordance with some configurations. FIG. 4 illustrates an example programmed cell 400, in accordance with some configurations.

### 2.2—Reliability of Flash Memory

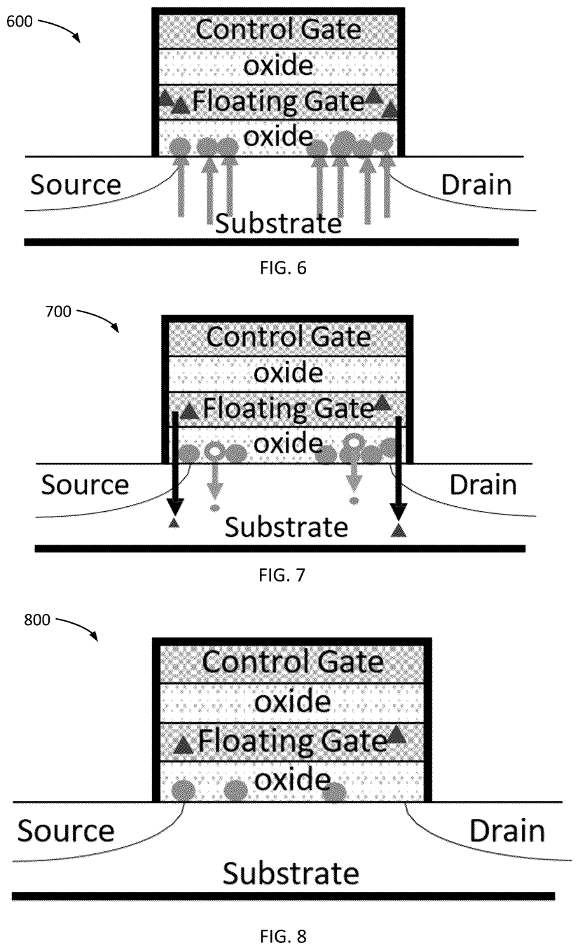

Some mechanisms related to reliability of flash memory may include: 1) trap-site generation, as illustrated in FIG. 5 by reference numeral 500; 2) trapping, as illustrated in FIG. 6 by reference numeral 600; 3) de-trapping and charge loss (e.g., discharging), as illustrated in FIG. 7 by reference numeral 700; and 4) trap recovery, as illustrated in FIG. 8 by reference numeral 800.

Trapping may be used as an umbrella term for overall stress (e.g., for both trap site generation and trapping) in some contexts. Charge loss (e.g., discharging) causes retention errors, but de-trapping improves reliability. Every erase and program operation causes stress on the oxide layer, which is an accumulation of positive (e.g., electron loss) and negative (e.g., electron gain or thermal emission) charges. Those charges (e.g., positive or negative) are discharged (e.g., de-trapped) from the oxide layer during relaxation time, which improves reliability. Trap recovery eliminates generated traps, so it is a more long-term solution. Discharging, de-trapping, and trap recovery are based on the same physical mechanisms. Discharging, de-trapping, and trap recovery accelerate with increased temperature.

A threshold voltage (Vₜₕ) of a transistor (e.g., floating-gate-transistor (FGT) or charge-trap-transistor (CTT), etc.) may be tuned by controlling the amount of electrons (e⁻) (e.g., negative charges). The more e⁻s in the transistor, the higher the Vₜₕ is. In order to move e⁻ to (e.g., a program operation) or from (e.g., an erase operation) the floating gate of FGT (or inner oxide of CTT), Fowler-Nordheim tunneling or Hot Carrier Injection methods may be used, depending on the technology and architecture. However, due to the probabilistic nature of these mechanisms, it may not be possible to obtain the exact Vₜₕ. Therefore, instead of relating the information to an exact Vin, the information may be related to a range of voltage values, which Vin can fall into with a certain probability.

### 2.2.1—Wearout in a Flash Cell

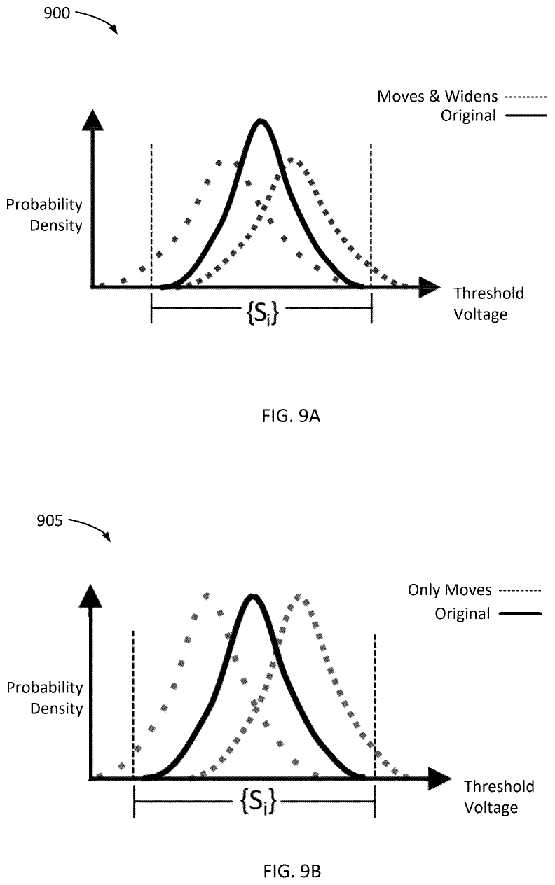

After programming a cell to a desired state (Sᵢ), the expected behavior of the cell is to keep the threshold voltage (Vₜₕ) within the boundary. FIGS. 9A-9B are graphs 900, 905 illustrating an example expected behavior with a solid line, in accordance with some configurations. However, the expected behavior wears out over time and causes degradation in the probability density function of the threshold voltage (Vₜₕ). Operating flash memory involves changing the threshold voltage (Vₜₕ) by programming and erasing the memory cell. This cycling process, driven by a high electric field, leads to trap formation, categorized as interface and bulk traps. Some of the factors disrupt the integrity of the probability density function (pdf) bell plot; it gets shorter and wider and is moved to the left or the right by such as program-erase (P/E) cycling, as illustrated in the graph 900 of FIG. 9A. Some factors do not alter the integrity, only shift it to the left or the right, such as discharging (e.g., retention loss), temperature, read and program disturbances, as illustrated in the graph 905 of FIG. 9B. These effects are not independent of each other. Rather, these effects are correlated.

### 2.2.1.1—Bit and Byte Error Rate (BER)

An error is observed when the information (state) received after a read operation does not match with the programmed information (state). An error may occur due to the threshold voltage (Vₜₕ) value falling outside of a boundary of the state, which is defined in the probability density function. For instance, when the threshold voltage (Vₜₕ) range of state Sᵢ is defined as [V₁, V₂], then the probability of getting the error (P(Error)) equals the probability of the threshold voltage (Vₜₕ) not being in the range of [V₁, V₂] (P(Vₜₕ∉[V₁, V₂])). This probability can be increased due to the factors described herein, such as, e.g., retention-time, temperature, read/program disturbs, trapping caused by P/E cycling, etc. Higher P/E cycle count (PEC) results in more deformation to the characteristics of pdf, which increases P(Vₜₕ∉[V₁, V₂]). Also, more time passes after the program yields more loss of charge, which again increases P(Vₜₕ∉[V₁, V₂]). In some experiments, the total errors in a block were counted, in which the sum of the error probabilities plays a role. BER is the rate of observed errors over the given capacity. The technology disclosed herein may utilize both bit and byte error rates; in the cases of BERs, BERs may be compared with error correction code by assuming all the bits in the byte are flipped.

### 2.2.1.2—Lifetime (Time-to-Failure)

Lifetime can be defined as the time span of flash memory usage (for storage or processing). The occurrence of an error, if mitigated, does not mean the end of the lifetime. The lifetime of flash is improved by mitigation techniques such as wear-leveling, over-provisioning, and the use of Error Correction Codes (ECC).

A model for Lifetime (in years) may be represented via the following:

$$\begin{matrix}Lifetime = \frac{total \# of Full Drive Writes}{\# of Full Drive Writes per year} \\ = \frac{PEC \times ( 1 + OP )}{365 \times DWPD \times WA \times {R}_{compress}}\end{matrix}$$

where PEC is P/E cycle count; OP is the over-provisioning ratio (extra_physical_address/logical_address); DWPD is the number of full writes per day; WA is write amplification; and R_{compress} is the compression ratio.

PEC is the number of writes performed until the raw BER of a block is not correctable with ECC. Therefore, if no ECC is used, then PEC will be equal to the P/E cycle count given in the datasheet of the product. Moreover, suppose a NAND flash block is processing data by using all physical addresses and performing a write-intensive application (DWPD is P/E cycles of all SSD per day); in that case, Lifetime will only depend on its endurance limitation (vendor data) and performance (P/E cycle per day). Thus, in some instances, for simplicity, only P/E cycle count for Lifetime (without ECC, with 1-bit-ECC, etc.) may be considered.

### 2.2.1.3—Erase and Program Operation Latency

Increase and change in the erase and program operation durations indicate the wear-out of the device. The increase in latency occurs due to the repetition of the erase operation until it is successfully erased. Unsuccessful erase operations indicate the block is degrading. The elapsed time may be divided by total PEC to find a single latency and report these average latency values.

### 3—Page Isolation: a Second Chance for End-of-Life Flash Memory Blocks

The goal of reliability and sustainability is to maintain data and device integrity as long as possible, reaching higher endurance levels.

As described herein, the Page Isolation technique involves isolating pages to mitigate cell-to-cell program interference, which is a dominant factor for the alteration of threshold voltage. When blocks age, all factors are combined to increase the threshold voltage overlaps of the states, which causes exceeding the correctable error limit. The main reason for the alteration of the threshold voltage of the victim cell is the parasitic capacitive coupling, which is inversely proportional to distance. This means closer neighbors will have a much greater effect than the distanced neighbors. Therefore, the Page Isolation technique suggests starting to isolate the pages by one page after reaching the uncorrectable error limit (or threshold) and increasing the number of isolating pages as needed. The Page Isolation technique enables the use of 50% and 33% of the end-of-life block pages for 3.5× and at least 7.7× beyond anticipated lifetime, respectively. Using two consecutive pages for isolation (e.g., 2-Page-Isolation) does not lead to any errors in the duration of the experiment, so it may be concluded that Page Isolation results in more than 7.7× lifetime improvement for some pages at 50° C.

Isolating the pages does not introduce any complex decisions during the implementation in the FTL of the SSD. Statically skipping some pages of aged blocks during the declaration of free addresses may be sufficient. A modification in the firmware may be adequate since the “bad block management”, “garbage collection”, and “address translator” algorithms of the FTL may be in place and take care of all the processes.

The highlights of the Page Isolation technique may include: 1) the Page Isolation technique is not an alternative to other techniques but rather complementary; 2) the Page Isolation technique enables the use of page addresses otherwise deprecated (this provides additional capacity); and 3) the Page Isolation technique does not introduce any complexity penalty.

### 3.1—Page-to-Page Interference

As described herein, flash cells or pages may not be independent of each other. Rather, in some instances, flash cells or pages may be: 1) linked with parasitic capacitance; 2) voltages are still applied to other pages during the operation of a page (program and read); or 3) cells share voltage nodes. These dependencies cause cell-to-cell disturbance while using flash by altering the threshold voltage or the sensed current of the target cell, causing errors. The most dominant cell-to-cell interference may be the effect caused by the Program operation due to the parasitic capacitance.

The capacitance of individual parasitic capacitors may be inversely proportional to the distance, but considering the serial capacitance formation, the parasitic effect of long-distanced capacitors may become negligible. The impact of direct-neighbor-pages ((n±1)^{th}) during programming (and reading) may be highest, and the impact may be diminished as the distance increases, such as, e.g., distanced-neighbor pages ((n±2)^{th}). When considering bias voltage conditions and others, experimental results may show that the effect of (n±2)^{th} pages are less than 10% of the effect of direct-neighbor-pages ((n±1)^{th}).

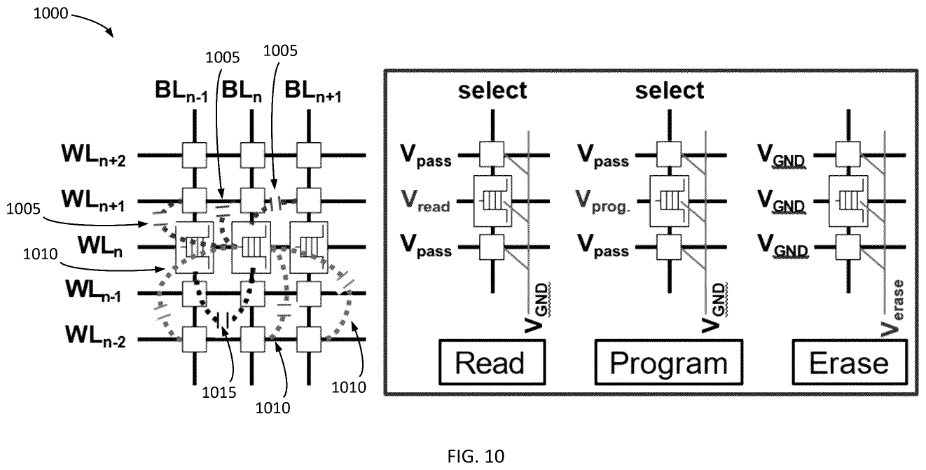

FIG. 10 illustrates an example diagram 1000 of interference capacitors, in accordance with some configurations. In order to increase clarity, only parasitic capacitors of victim cell Cell_{n,n} with top-direct-neighbors (represented in FIG. 10 by reference numeral 1005) and bottom-distanced-neighbors (represented in FIG. 10 by reference numeral 1010) are illustrated in the diagram 1000. As illustrated in FIG. 10, the diagram 1000 also illustrates parasitic capacitance between cells in the same WL (represented in FIG. 10 by reference numeral 1015). Even distant neighbor pages can affect each other as such distant neighbor pages may contribute to the load of the shared bit-line, yet the distant neighbor pages may be considered negligible in the lights of the experimental results described herein. As flash memory blocks age, the flash memory blocks may become more susceptible to cell-to-cell interference, which may cause uncorrectable errors and reduces block endurance. This is a problem at the fundamental operation and the architecture of NAND flash regardless of the type of NAND flash. Therefore, the technology disclosed herein proposes a Page Isolation technique that applies to any flash type, which aims to minimize and mitigate the mentioned dependencies in already-aged blocks.

### 3.2—Page Isolation Technique

The technology disclosed herein provides a Page Isolation technique for blocks that have reached and passed their end-of-life, deemed unusable (e.g., “bad” blocks). The Page Isolation technique does not cause any capacity loss. Rather, for aged flash memory, the Page Isolation technique prevents capacity loss. In an SSD, addresses of “bad” blocks are removed from the free address list in the FTL. The technology disclosed herein may prevent at least 50% from being removed from the list. The Page Isolation technique uses neighboring pages for isolation and gives a second chance to the rest of the pages in already-aged blocks.

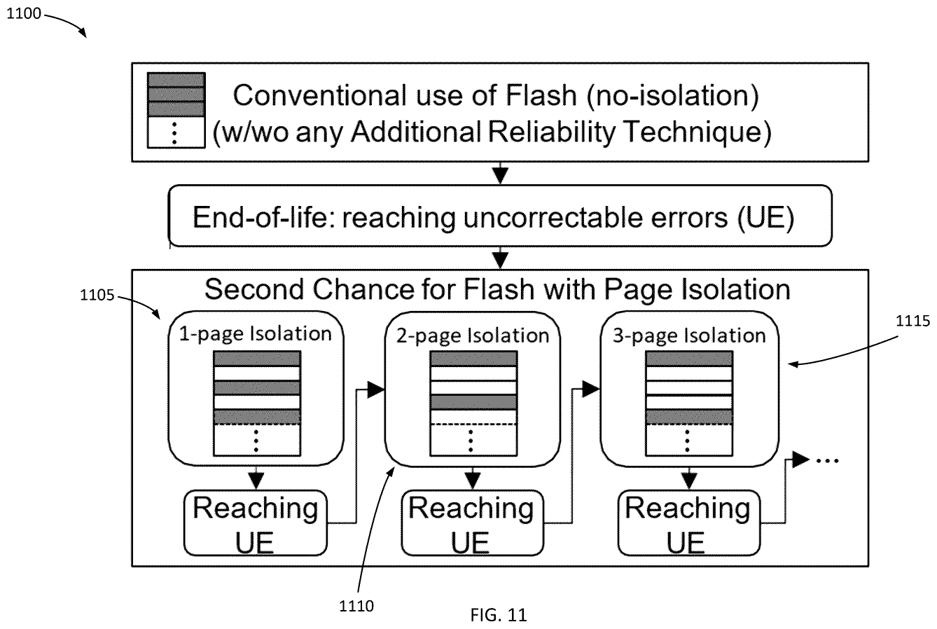

FIG. 11 illustrates an example implementation 1100 of the Page Isolation technique, in accordance with some configurations. As illustrated in FIG. 11, the implementation 1100 may begin with a 1-page isolation (represented in FIG. 11 by reference numeral 1105), using every other page in an aged block, and increasing the number of isolation pages after reaching uncorrectable errors. For instance, as illustrated in FIG. 11, after a 1-page isolation, a 2-page isolation (represented in FIG. 11 by reference numeral 1110) may be implemented, and subsequently a 3-page isolation (represented in in FIG. 11 by reference numeral 1115) may be implemented, etc.

Existing system-level solutions, like, e.g., over-provisioning or wear-leveling, do not adequately address blocks that have reached end-of-life, resulting in premature block retirement and reduced storage efficiency. Existing system-level solutions focus on adapting the system to the endurance limitations and increasing the reliability within a given setup.

On the other hand, the methods that target cell-to-cell interference fail to utilize blocks that have reached the error threshold, resulting in inefficiencies and waste. One approach proposes changing the page assignment and cell access patterns to reduce the effect of direct neighbors. Another approach proposes calibrating the read reference voltage by estimating the shift caused by cell-to-cell interference.

The technology disclosed herein implements a technique that is orthogonal and complementary to the prior techniques since the proposed technique enables the reuse of already-aged blocks. Page Isolation does not restrain the usage of other techniques. For example, such other techniques may be utilized during the phase of the “second life” with Page Isolation.

### 3.3—Experimental Results

Experiments were tested in a temperature-controlled environment with a two-dimensional planar SLC NAND flash memory. Even though the technique described herein is type-independent, multi-level (e.g., MLC, TLC, etc.) type flash memories may benefit as such flash memory types may be more susceptible to cell-to-cell interference.

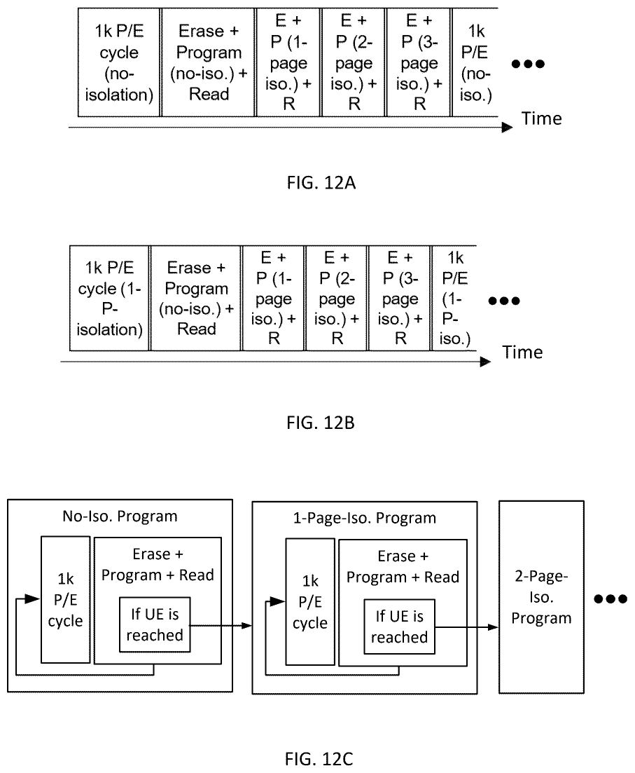

FIGS. 12A-12C illustrate experimental schemes for comparison of page isolation methods and no-isolation at a given age, in accordance with some configurations. In particular, FIG. 12A illustrates an experimental scheme with no-isolation programming, in accordance with some configurations. FIG. 12B illustrates an experimental scheme with 1-page-isolation programming during cycling and collecting error rate for methods at every 1 k P/E cycle, in accordance with some configurations. FIG. 12C illustrates a synthesized technique involving switching page isolation as error count reaches a limit, in accordance with some configurations.

As illustrated in FIGS. 12A-12C, a block with intervals of 1000 (1 k) P/E cycles was aged. Two different aging (cycling) schemes were tested, including: 1) programming all pages (no-isolation), as illustrated in FIG. 12A; and 2) programming every other page (1-Page-isolation), as illustrated in FIG. 12B. After each 1 k P/E cycle, time-0 errors were measured using four methods: 1) program without isolation (e.g., baseline, programming every page); 2) program with 1-page isolation (e.g., prog. every other page); 3) program with 2-page isolation (e.g., prog. every other two pages); and 4) program with 3-page isolation (e.g., prog. every other three pages). One erase operation and one read operation were performed before and after these programming methods, respectively. The isolation pages were not programmed. Rather, the isolation pages were left erased. The experiments were run at 25° C., 50° C. and 95° C. for P/E cycles but used 50° C. while comparing different schemes. Two types of data were used: 1) data all zero (e.g., highest programming state); and 2) random data.

3.3.1—Programming with Page Isolation at a Given Age

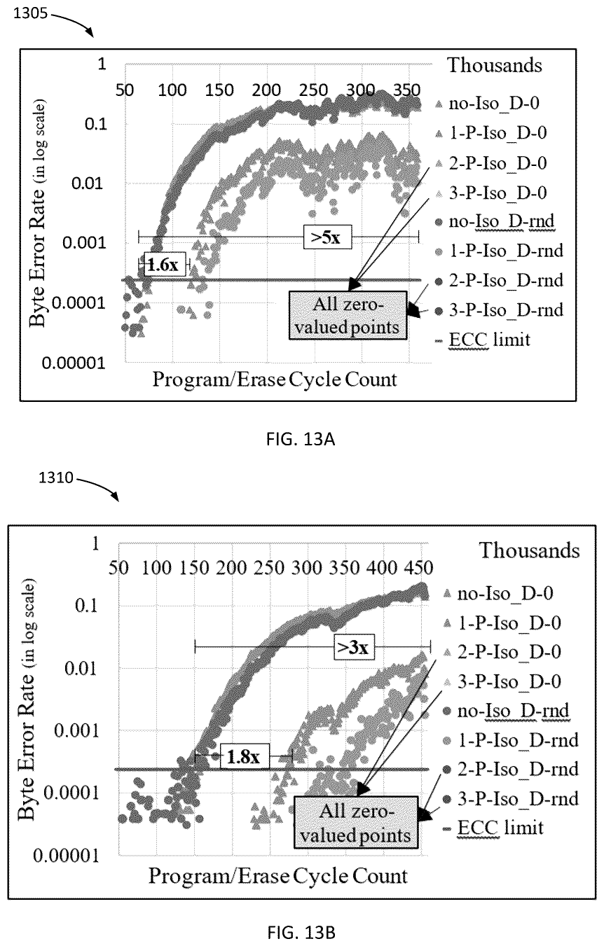

The BER results of experiment schemes of FIGS. 12A and 12B are reported in FIGS. 13A and 13B, respectively. FIG. 13A is a graph 1305 of BER results for Page Isolation with regular stress cycling (with no-isolation during cycling) according to some configurations (e.g., the scheme illustrated in FIG. 12A). FIG. 13B is a graph 1310 of the BER results for Page Isolation with reduced stress cycling (with 1-page-isolation during cycling) according to some configurations (e.g., the scheme illustrated in FIG. 12B). Each graph 1305, 1310 compares the BER of different numbers of page selections at a given age. As illustrated in FIGS. 13A-13B, triangle points indicate data-0 and circle points indicate random data. Zero-valued points are not shown in the graphs 1305, 1310. 2-Page-Iso. and 3-Page-Iso, methods did not result in any errors. The experiments are conducted at 50° C. These results demonstrate the error rate of which the block is programmed in a certain way (no-isolation, 1-Page-Isolation, 2-Page-Isolation, and 3-Page-Isolation; with data-0 and data-random) and read at a given age. As described herein and illustrated in FIGS. 13A-13B, the only difference between the graphs 1305, 1310 is that all pages programmed for FIG. 13A and every other page is programmed for FIG. 13B during the aging (e.g., cycling) of these two blocks.

As illustrated in FIGS. 13A-13B, the Page Isolation technique allows the use of pages in aged blocks beyond a conventional lifetime of the aged blocks (e.g., no-isolation). This lifetime is 75 k (in FIG. 13A) and 125 k (in FIG. 13B) P/E cycles, where the block reaches the ECC limit when no isolation is performed. The 1-page isolation method enables the use of half of the pages of the aged block for an additional 50 k (in FIG. 13A) and 150 k (in FIG. 13B) P/E cycles (66% and 80%) before reaching the ECC limit. The BER is reduced by around 120× at 125 k P/E cycles for Data-0 (fully programmed cells) in the case of FIG. 13A. The Page Isolation technique performs similarly with the random data values, if not better. Furthermore, 2-page and 3-page isolation methods did not present any errors for the duration of the experiments (e.g., 375 k and 450 k P/E cycles), which is 3× and 5× more than the baseline lifetime. Thus, in some configurations, the technology disclosed herein may be implemented by starting with 1-page isolation and switching to 2-page isolation after reaching the ECC limit. The effects of far neighbor pages (e.g., further than (n±2)th) may be negligible. Therefore, in some cases, the 2-page isolation method may increase the lifetime more significantly than the 1-page isolation method does, and switching to the 3-page isolation may not occur.

Aging with programming fewer pages reduces the stress. Therefore, we observed a higher endurance in FIG. 13B than in FIG. 13A. All three temperature points that were tested had similar characteristics with different endurance improvements. When random data is programmed into the pages without any isolation, the errors started to reach ECC-limit around 90 k, 77 k, and 55 k P/E cycles at 25° C., 50° C. and 95° C., respectively. In the case of 1-Page-Isolation, the errors started to reach ECC-limit around 117 k and 125 k at 25° C. and 50° C., respectively. At 95° C., zero error is measured when the Page Isolation technique is in use. This gives results in endurance improvements of 1.3×, 1.6×, and more than 18× (considering the end of the experiment is IM P/E cycles) at 25° C., 50° C., and 95° C., respectively.

### 3.3.2—Equalizing the Read-Disturb Effect

Page Isolation may mitigate both program-interference and read-disturb since the number of occupied pages will be reduced when some are used for isolation. The effect of Page Isolation on program-interference was investigated separately by equalizing the read operation done during error detection.

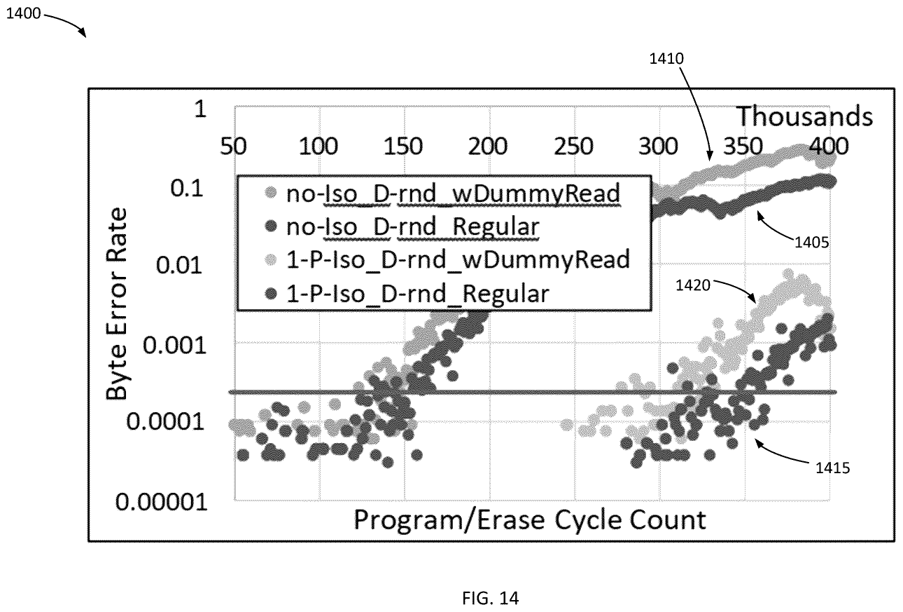

FIG. 14 is a graph 1400 illustrating a comparison between the proposed-regular Page Isolation and Page Isolation with dummy reads. The data representative of the no-isolation regular is represented in FIG. 14 by reference numeral 1405. The data representative of the no-isolation, dummy reads is represented in FIG. 14 by reference numeral 1410. The data representative of the 1-Page-Isolation, regular is represented in FIG. 14 by reference numeral 1415. The data representative of the 1-Page-Isolation, dummy reads is represented in FIG. 14 by reference numeral 1420.

The experimental scheme illustrated in FIG. 13B with 50° C. was used for this comparison (as illustrated by the graph 1400 of FIG. 14). Most of the benefit is in the program interference since it is a dominant factor. The endurance improvement without the dummy read (e.g., regular Page Isolation) and with the dummy read (e.g., equalized read disturbance) is 2.4× and 2.3×. Thus, it may be concluded that the ratio of the mitigation effect of Page Isolation on Program-Interference and Read-Disturb is 130% to 10%.

3.3.3—Increasing the Lifetime with Page Isolation

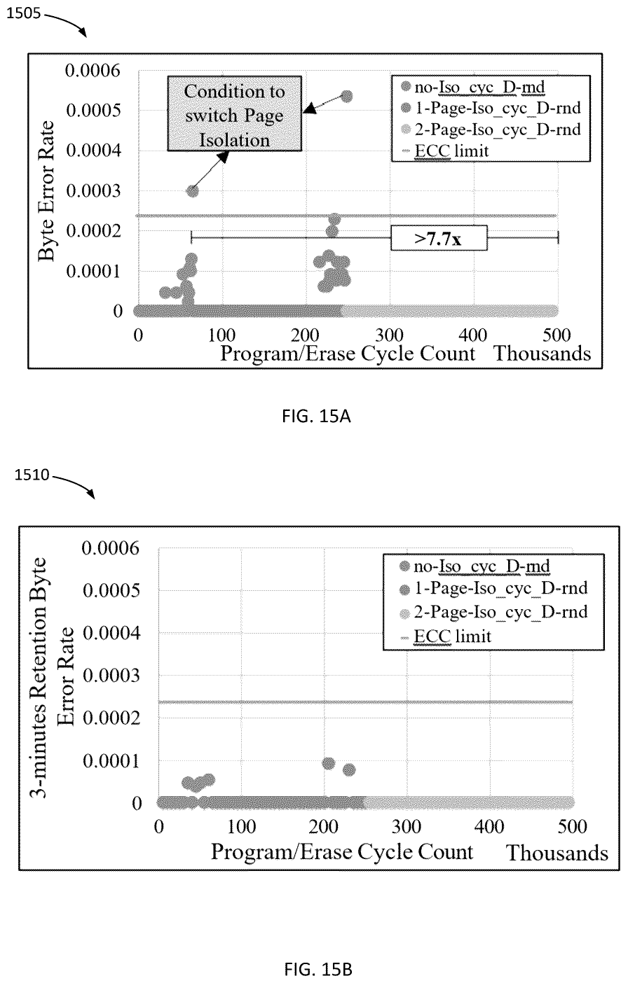

In light of all the analysis experiments described herein, an experiment was performed that detects both time-0 and 3-minute retention errors for the proposed Page Isolation technique at 50° C. In this experiment, the same programming scheme was used for both aging and error detection and random data patterns were used. The experiment started with no-isolation, and after reaching the ECC limit, the experiment was switched to 1-Page-Isolation. After that, the experiment was switched to 2-Page-Isolation, but the experiment was not switched to 3-Page-Isolation (since no errors were observed after switching to 2-Page-Isolation). FIGS. 15A and 15B illustrate the results of this experiment. In particular, FIG. 15A is a graph 1505 illustrating the results with respect to time-0 retention errors. FIG. 15B is a graph 1510 illustrating the results with respect to 3-minuets retention errors. The technique presents 3.5× endurance improvement for 50% of the aged pages (e.g., 1-Page-Isolation) and more than 7.7× improvement for 33% (e.g., 2-Page-Isolation). No errors were observed for the duration of the experiment (e.g., 500 k) with 2-Page-Isolation. Therefore, the actual endurance improvement may be much higher for 2-Page-Isolation and 3-Page-Isolation. As can be seen in FIG. 15B, the retention test also presents similar results to the time-0 experiment.

### 3.3.4—Data Pattern Dependency and Cycling Latency as an Aging Metric

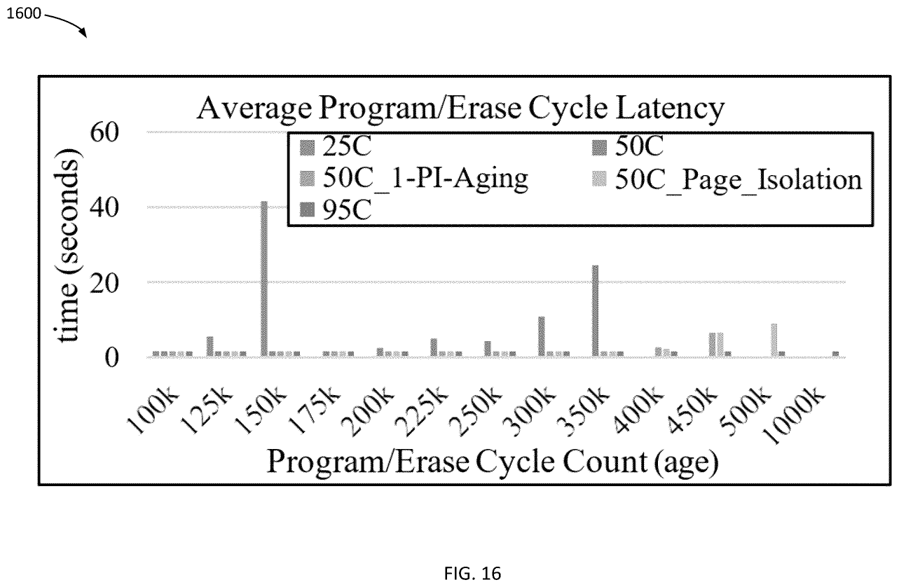

During the experiments, the elapsed time of each 1000 P/E cycles were measured to monitor the wear-out with another metric other than the error rate. The increase in the latency occurs due to the repetition of the erase operation until it is successfully erased. Unsuccessful erase operations indicate the block is getting age. The elapsed time was divided by 1000 to find a single latency and report these average latency values in FIG. 16. FIG. 16 is a graph 1600 illustrating average P/E cycling latency at around the given age. Increasing latency indicates wear-out due to the repetition of the required erase operations. The graph 1600 illustrates the results for experiments performed with the scheme of FIG. 12A at 25° C., 50° C., and 95° C., and with the schemes of FIG. 12B and FIG. 12C at 50° C. The latency remains steady until 400 k P/E cycles in the case of Page Isolation, which the scheme in FIG. 12C at 50° C. Therefore, for the applications in which performance is crucial, the lifetime improvement will be translated to 6.25× instead of 7.7× as mentioned previously (in FIGS. 15A-15B).

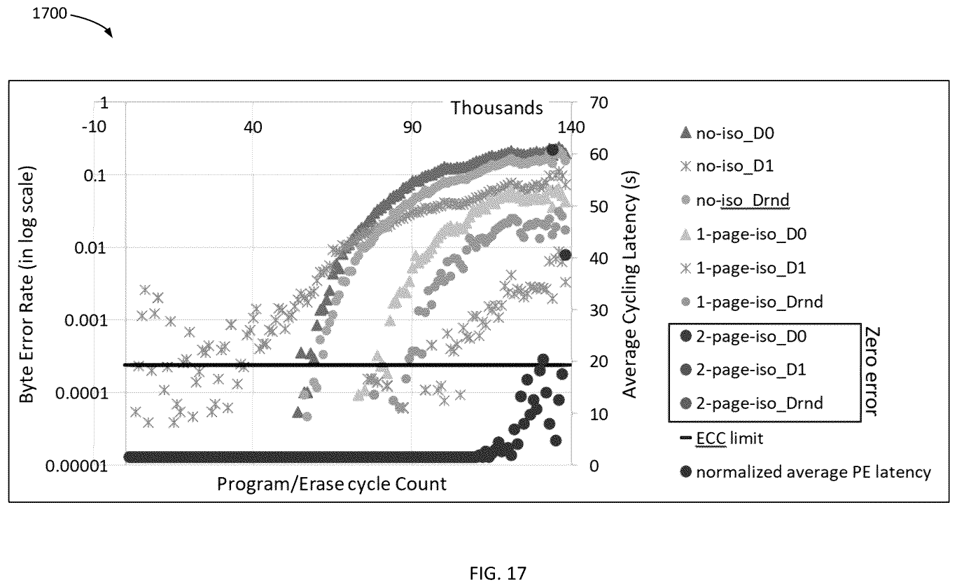

An experiment with a data pattern of all 1s (ones: data-1) was also run and compared it with random and all 0s (zeros: data-0) data patterns, as illustrated in FIG. 17. FIG. 17 is a graph 1700 illustrating a BER comparison of Page Isolation including data-1 pattern at 25° C. by using the aging method of FIG. 12A. Triangle, Cross and Circle points indicate data-0, data-1 and random data, respectively. Zero-valued points are not shown in the graph 1700. 2-Page-Iso. and 3-Page-Iso, methods did not result in any errors. As illustrated in FIG. 17, data-1 starts to show errors earlier, but after the error related to aging becomes dominant, data-1 presents fewer errors than data-0 and random data. Overall, data-1 benefits from Page Isolation more than the other data patterns.

### 3.3.5—Retention Errors

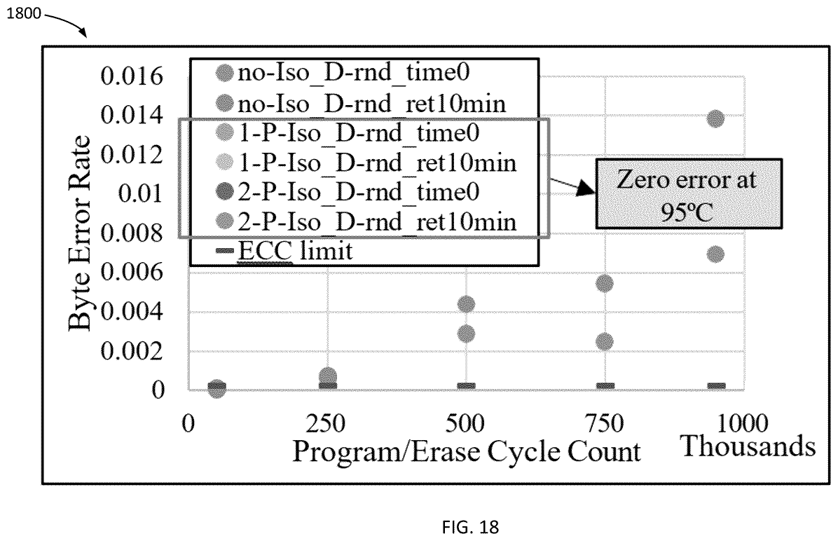

FIG. 18 is a graph 1800 illustrating a 10-minute retention test and performance of Page Isolation at 95° C. As illustrated in FIG. 18, Page Isolation gives no errors until IM P/E Cycle. This translates to an improvement more than an 18× endurance improvement, even for 1-Page-Isolation. As illustrated, an improvement of a magnitude of 7.7× at 50° C. may occur.

### 3.4—Conclusion and Future Works

The proposed Page Isolation technique, which can be applicable to any flash type, allows using at least 50% of pages of an aged block, which would otherwise be removed from the free block list. As described herein, some configurations aim to reduce the dependency by utilizing some aged blocks for isolation. The comprehensive experiments described herein prove that Page Isolation reduces waste by giving abandoned pages a second life. Page Isolation increases the endurance of such pages by, e.g., at least 6.25×. Since Page Isolation can be implemented statically in the FTL firmware, Page Isolation does not introduce any penalty. The Page Isolation technique described herein may be implemented into the FTL and may be tested with an SSD simulator to assess the system-level implications and endurance and capacity improvements.

### 4—Recovery-Aware and Program-Interference-Tolerant Flash Translation Layer (FTL)

### 4.1—Solid State Drives' Flash Translation Layer

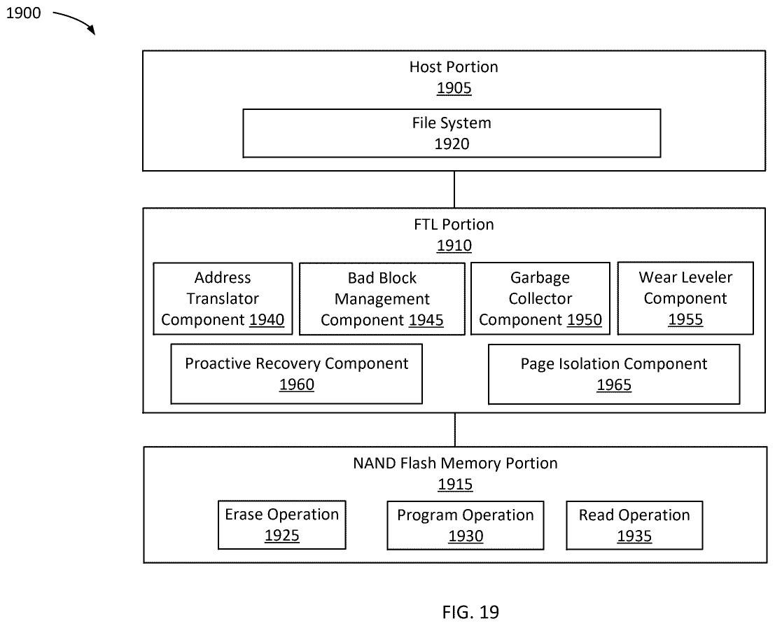

FTL is a layer in the use of flash that is responsible for functionality while optimizing the performance, power, and reliability of the flash. FIG. 19 schematically illustrates an example memory architecture 1900, in accordance with some configurations. As illustrated in FIG. the memory architecture 1900 includes a host portion 1905, a FTL portion 1910, and a NAND flash memory portion 1915. In the illustrated example, the host portion 1905 may include a file system 1920. The NAND flash memory portion 1915 includes an erase operation 1925, a program operation 1930, and a read operation 1935. The FTL portion 1910 may include an address translator component 1940, a bad block management component 1945, a garbage collector component 1950, and a wear leveler component 1955. As illustrated in the example of FIG. 19, the FTL portion 1910 may further include a Proactive Recovery component 1960 (e.g., a Circadian Rhythm Scheduler) and a Page Isolation component 1965.

Flash memory technology may follow an erase-before-program protocol. The erase operation occurs at the block level, while the program operation takes place at the page level. Pages are contained within the block. An unprogrammed page is called a free page. The page that has valid data is called a valid page. A valid page becomes invalid when the data in the page is considered to be erased or changed.

In order to avoid erasing a block while there are unprogrammed pages (e.g., free pages) in the block, the physical address (PA) of the page is changed while keeping the logical address (LA) unchanged, which is known by the host. The previous PA of the LA is declared an invalid page address, and the currently assigned PA becomes a valid page address. An address translator (e.g., the address translator component 1940) may assign and keep track of the mapping of PAs and LAs. The free, valid, and invalid pages are kept in the list called the pool.

After a block is full and the block has more invalid pages than valid pages, garbage collection (GC) algorithm (e.g., the garbage collector component 1950) may transfer valid data elsewhere, with the help of address translator (e.g., the address translator component 1940), and erases the block. The pages in the erased block are put into the free page pool if the block is not considered “bad.” A wear-leveler (e.g., the wear leveler component 1955) may select the block behind the garbage collector (e.g., the garbage collector component 1950). The load (e.g., Program and Erase counts) of every block is desired to be balanced and distributed. The garbage collector (e.g., the garbage collector component 1950) may select the blocks among the blocks that have the least erase count when wear leveling is enabled. Also, garbage collection (e.g., via the garbage collector component 1950) may start to take place after a threshold of the free pages (e.g., free capacity) to case the burden of write amplification caused by the garbage collector (e.g., the garbage collector component 1950).

Write amplification and reliability can be managed with the overprovisioning percentile. The over-provisioning technique adds spare (e.g., redundant) capacity to flash. The spare capacity does not reflect the capacity of the user experience. Due to process variability, some blocks might be less reliable. Data traffic may be forwarded away from the “bad blocks” by bad block management (e.g., the bad block management component 1945). As illustrated in FIG. 19, the FTL portion 1910 may be placed between the file system 1920 of the host portion 1905 and flash memory (e.g., the NAND flash memory portion 1915). Physically, the FTL portion 1910 may reside in the host (e.g., the host portion 1905), in the SSD controller, or in the flash die.

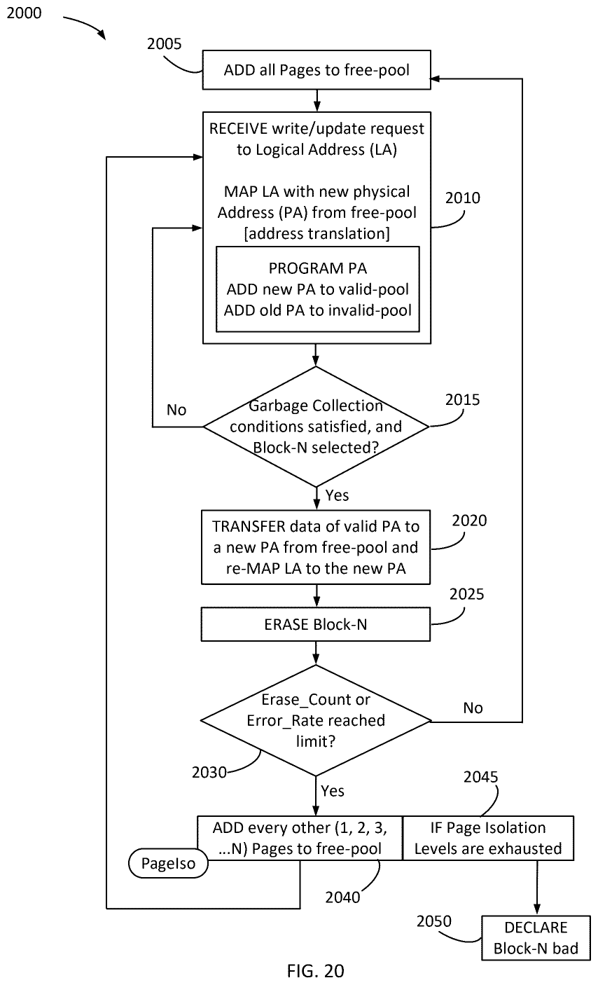

FIG. 20 is a flowchart of illustrating an example method 2000 for implementing Page Isolation according to some configurations. At step 2005, all pages are added to the free-pool. At step 2010, write/update requests to logical address (LA) may be received. Additionally, in some instances, at step 2010, address translation may occur (e.g., mapping LA with new physical address (PA) from free-pool). For instance, new PA may be added to valid-pool and old PA may be added to invalid-pool. At step 2015, it may be determined whether garbage collection conditions are satisfied and whether Block-N is selected. When garbage collection conditions are not satisfied and Block-N is not selected (i.e., “No” at step 2015), the method 2000 may return to step 2010. When garbage collection conditions are satisfied and Block-Nis selected (i.e., “Yes” at step 2015), the method 2000 may proceed to step 2020. At step 2020, data of valid PA may be transferred to a new PA from free-pool and the LA may be re-mapped to the new PA. At step 2025, Block-N may be erased. At step 2030, it may be determined whether Erase_Count or Error_Rate (e.g., error limit or threshold) has reached limit. When the limit has not been reached (i.e., “No” at step 2030), the method 2000 may return to block 2005. When the limit has been reached (i.e., “Yes” at step 2030), the method 2000 may proceed to step 2040. At step 2040, page isolation may be implemented. For instance, for 1-page isolation, every other page may be added to the free-pool. For 2-page isolation, every second page may be added to the free-pool. For 3-page isolation, every third page may be added to the free-pool. After every nth page is added to the free-pool, the method 2000 may return to step 2010. In some instances, when page isolation levels are exhausted (e.g., at step 2045), the Block-N may be declared as bad (e.g., at step 2050).

Accordingly, in some configurations, the Page Isolation technique may be integrated into the collection of “address translation”, “bad block management”, and “garbage collection” modules, as described herein. To implement the Page Isolation technique, the modification will be minimal. For example, only the free-page assignment method may be adjusted for the “Page Isolation” (e.g., step 2040 of the method 2000 of FIG. 20).

In some instances, the block may be used with the conventional (no-isolation) method until a condition of the block reaches the limit that it is to be declared as “bad” (e.g., at step 2030 of the method 2000 of FIG. 20), such as, e.g., an error limit or threshold. After reaching the limit, which isolation method to use (1-page, 2-page, etc.) may be determined, adding only the pages other than the isolation pages. FTL may add 50%, 33%, or 25% of pages to the free-list instead of losing those pages. The technology disclosed herein may start with 1-Page-Isolation, and the number of isolation pages may increase as the condition worsens (e.g., to 2-page isolation, 3-page isolation, n-page isolation, etc.). Considering this decision and the page selection method being static, a firmware update can utilize the Page Isolation technique without involving hardware computational complexity.

### 4.4—Enhancing an SSD Simulator for System-Level Reliability Assessment.

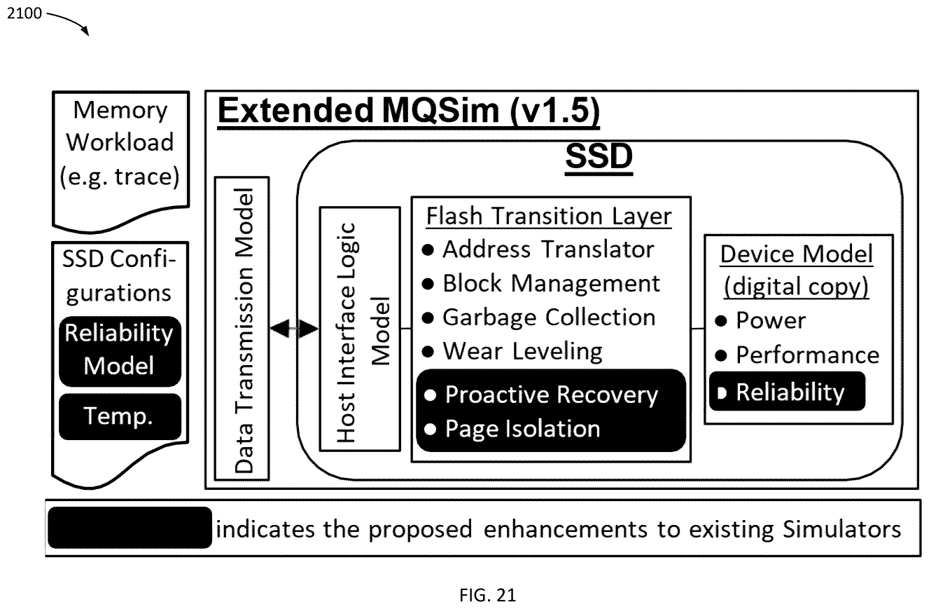

The proposed reliability simulation algorithm may accommodate various types (or variations) of NAND flash technologies, as well as devices from various vendors. The proposed reliability simulation algorithm may simulate, at the block-level, BERs based on the device-level threshold voltage shifts. However, at the die-level, a higher level of abstraction may be involved, which may be the endurance metric. Reliability assessment may be performed by examining total byte write (TBW) and drive writes per day (DWPD), as described herein. The proposed enhanced SSD simulator, which may be based on a state-of-the-art SSD simulator, may analyze the reliability behaviors at the system-level, as illustrated in FIG. 21. FIG. 21 schematically illustrates the proposed enhanced SSD simulator 2100 in accordance with some configurations.

### 4.4.1—Selecting the SSD Simulator

Among existing SSD simulators, such as, e.g., MQSim, Amber (SimpleSSD 2.0), NVMe Virt, and MQSim-E, MQSim was identified as suitable candidates for reliability simulation enhancement. An enhanced version of the simulator may obtain the memory workloads or SSD configurations (e.g., including memory technology information); and the simulator may simulate power, performance (e.g., along with timing information), and reliability altogether. Reliability simulations may include error rate and endurance calculations. For example, MQSim may be capable to receive memory traces as memory workloads, record the duration of every data movement and operation, and reveal FTL operations, such as, e.g., address translation, wear-leveling, or garbage collection in C++ language. MQSim may also be open to integrate the proposed FTL, as described herein, due to explicit documentation. For instance, when MQSim is run for the small version of Microsoft enterprise memory traces, simulation details were achieved, such as, e.g., 3458 ns response time, 4405 program commands, and 0 erase commands with 70% initial occupation. Such details may contain the information for the proposed model to analyze the reliability characteristics of devices.

4.4.2—Extending MQSim with Reliability Analysis: MQSim-Reliability (MQSim-v1.5)

The original version of the MQSim, as well as MQSim-E, is not capable of reliability assessment. The current version of MQSim retrieves the “endurance” parameter but does not perform any analysis. As such, the current version of MQSim lacks the “Bad Block Management” capability of an FTL. In order to increase assessment efficiency during simulation, a parameter was added to define an initial wear-out state of the SSD, as well as support for heavy workloads. Therefore, before adding the techniques described herein to the FTL, the following features were incorporated into MQSim (forming an enhanced version referred to herein as MQSIM-v1.5): (1) Bad Block Management; (2) SSD Preconditioning Wear-out; (3) support for custom large trace files; (4) improved statistics, including, e.g., dynamic information as the simulation progresses; and (5) bug fixes, refactoring, and improved readability and user-friendliness.

As one specific example, the technology disclosed herein may introduce new parameters for reliability analysis, such as: (1) <Initial_Erase_Count>; (2) <Proactive_Recovery_Time_Interval>; (3) <Proactive_Recovery_Erase_Interval>; (4) <Proactive_Scale_Factor>; (5) and <Page_Isolation_Threshold_1>.

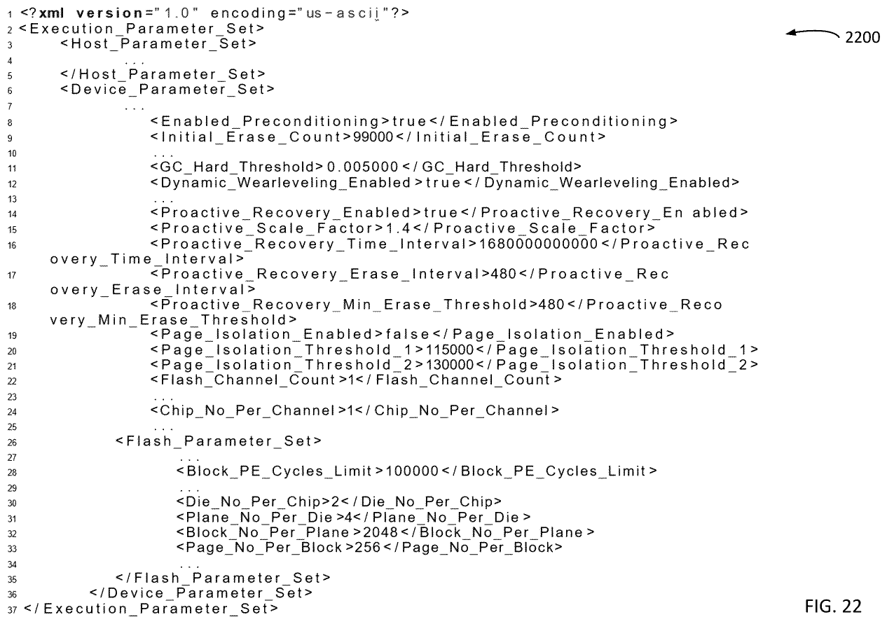

FIG. 22 is a snippet 2200 of a sample SSD configuration file that shows reliability-related parameters, in accordance with some configurations.

Endurance values may be extracted from a generated model file and written in an SSD configuration file. In some configurations, the model file may be designed to include one or more endurance values for different conditions of temperature, Proactive Recovery, Page Isolation, or a combination thereof. In some specific configurations, the model file may be designed to include all endurance values for different conditions of temperature, Proactive Recovery, and Page Isolation. However, MQSim may only utilize one endurance value. For automated batch simulation, a script can generate a configuration file (e.g., “ssdconfig.xml” file) for the specific condition.

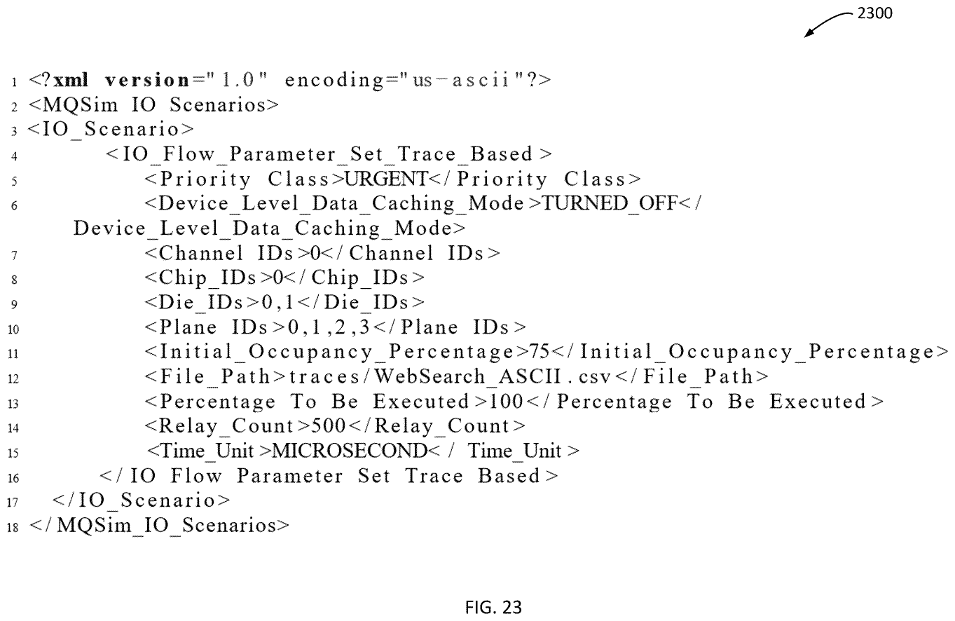

FIG. 23 is a snippet 2300 of a sample workload definition file, in accordance with some configurations. In the example of FIG. 23, the sample workload definition file points to trace file for the WebSearch workload.

In some configurations, the following commands may be used to run a simulation for a given condition. For example, the following command may be utilized to run MQSim on Linux: ./MQSim-i ssdconfig_sample.xml-w workload_sample.xml. For example, the following command may be utilized to run MQSim on Windows: MQSim.exe-i ssdconfig_sample.xml-w workload_sample.xml

### 4.5—Simulation Results: System-Level Implications of Proactive Recovery and Page Isolation

To assess the system-level implications of Proactive Recovery and Page Isolation techniques, the Proactive Recovery and Page Isolation techniques may be embedded into the FTL within MQSim, as described herein. Two investigations were conducted related to using the enhanced simulator described herein for reliability analysis: 1) the viability of Proactive Recovery and Page Isolation; and 2) the effect of Proactive Recovery timing parameters on the number of recovering blocks.

When Proactive Recovery puts a block into the recovery pool list, the available capacity is temporarily reduced. Blocks usually go into recovery before others go out. This might create a constant capacity loss. As discussed herein, the sustainability calculation may not be equivalent to the endurance (e.g., lifetime) improvement. Sustainability may be calculated by dividing endurance by the required additional capacity (which may compensate for the maximum capacity loss).

In some configurations, Page Isolation suggests using 50%, 66%, and 75% of the capacity for 1-page, 2-page, and 3-page isolation methods for the end-of-life blocks. Whether these limited capacities are adequate to perform the workload were analyzed.

MQSim-v1.5 enables the exploration of the effect of different circadian rhythms of flash on the number of recovering blocks. This helps designers pick the appropriate circadian rhythm for their application.

### 4.5.1—Simulation Setups and Configurations

The goal of the simulations is to test the implications of Page Isolation at the system level, not to assess the contribution of Page Isolation to the endurance of the flash. The capacity of the SSD were selected to be 64 GB and 24 GB to ensure efficient simulation time for the viability simulation and circadian rhythm comparisons, respectively. The individual capacity parameters are listed in Table 4.1 below. Note that the “Block Number per plane” affects the capacity when Page Isolation are enabled since the garbage collection occurs at the plane level.

| Parameter | for Simulation in Section 4.5.2 |
|---|---|
| Number of channels | 1 |
| Chip number per channel | 1 |
| Used Dies per chip | 2 |
| Used Planes per die | 4 |
| Block number per plane | 4096 |
| Page number per block | 256 |
| Page size | 8192 Bytes |

### 4.5.2—Viability Analysis of Page Isolation

In the viability analysis, an answer to the following question was sought: questions were sought: “Can the system still function with the lower capacity after end-of-lifetime with Page Isolation?” Four configurations were simulated: 1) Circadian Rhythm [120-7m] without Page Isolation; 2) Circadian Rhythm [120-15m] without Page Isolation; 3) Circadian Rhythm [120-7m] with Page Isolation; and 4) Circadian Rhythm [120-15m] with Page Isolation.

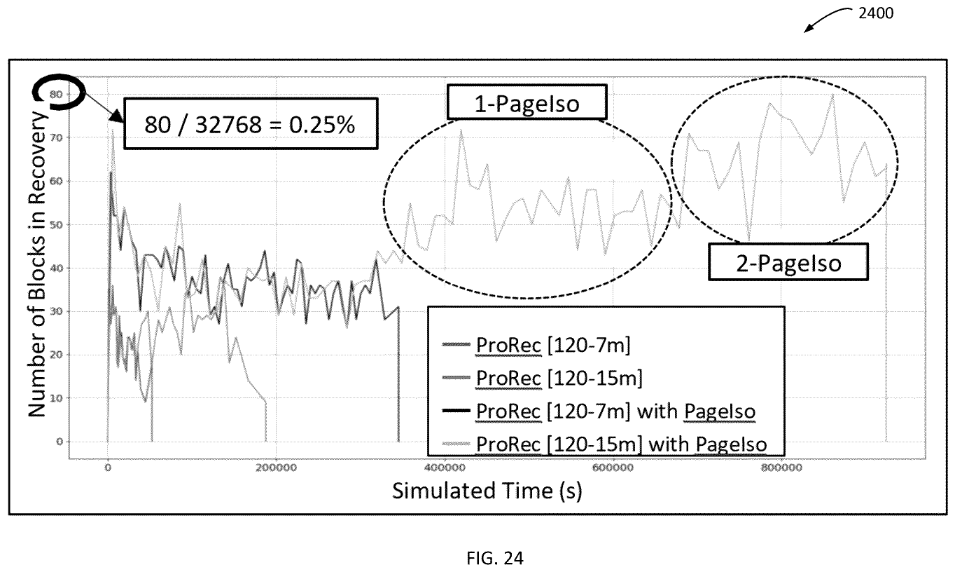

FIG. 24 is a graph 2400 illustrating the number of blocks in recovery at a given time while enabling Proactive Recovery and Page Isolation, in accordance with some configurations. As illustrated in FIG. 24, blocks go into the recovery pool after the blocks reach the 120 erase count and stay there for either 7 minutes (for [120-7m]) or 15 minutes (for [120-15m]). A WebSearch workload was used in the Samsung 980 Pro SSDs with the configuration in the second column of Table 4.1 (above).

Simulations result in the maximum number of blocks in recovery being less than 80 with the setup and configuration presented in Section 4.5.1. Therefore, the maximum required block is 80 out of 4096×4×2=32552 blocks. So, with a 0.25% additional capacity increase, the reliability improvement of Proactive Recovery (1.1× to 9×) is achieved. To calculate the sustainability improvement, the endurance improvement may be divided by 1.0025. Thus, it may be concluded that sustainability improvements are as high as reliability improvements.

Furthermore, FIG. 24 illustrates how long a simulation can continue with the given configurations. The simulation ends either when no blocks are left in the free pool or when the workload finishes. We made sure that the workload is large enough to force the simulation to end due to aged blocks. As can be seen in FIG. 24, the simulation “Circadian Rhythm [120-15m] with Page Isolation” lasts even when 2-page-isolation is activated. During 2-page-isolation, only 33.3% of the initial capacity can be used. Thus, this analysis shows that Page Isolation is still practical even with a 66% capacity reduction.

### 5—Conclusion and Broadening the Impact

### 5.1—Page Isolation for 3D NAND Flash

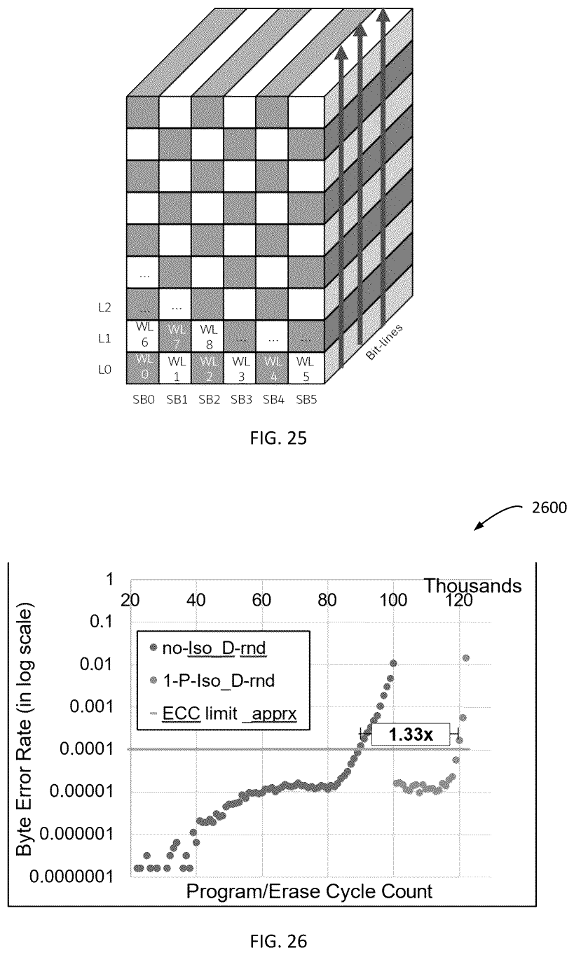

In some configurations, Page Isolation may be implemented at the 3D flash memory. The 3D NAND flash array is formed by sub-blocks and layers; the number of word lines doesn't always increase in the BL direction. Therefore, the techniques described herein were adjusted accordingly. FIG. 25 illustrates Level-1 page isolation for 3D NAND similar to 2D NAND according to some configurations. Results for the 1-sub-block isolation indicate that 3D shows similar results with 2D, as illustrated in FIG. 26. FIG. 26 is a graph 2600 illustrating 1-Sub-Block Isolation results, according to some configurations.

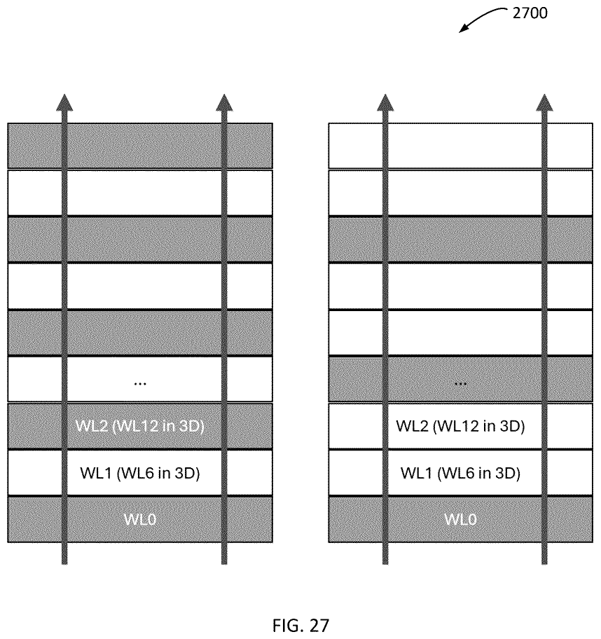

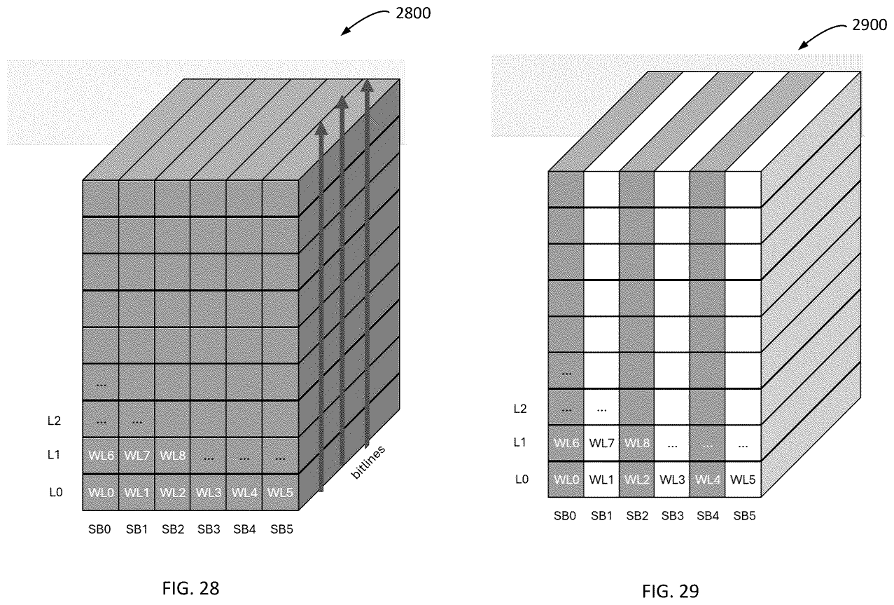

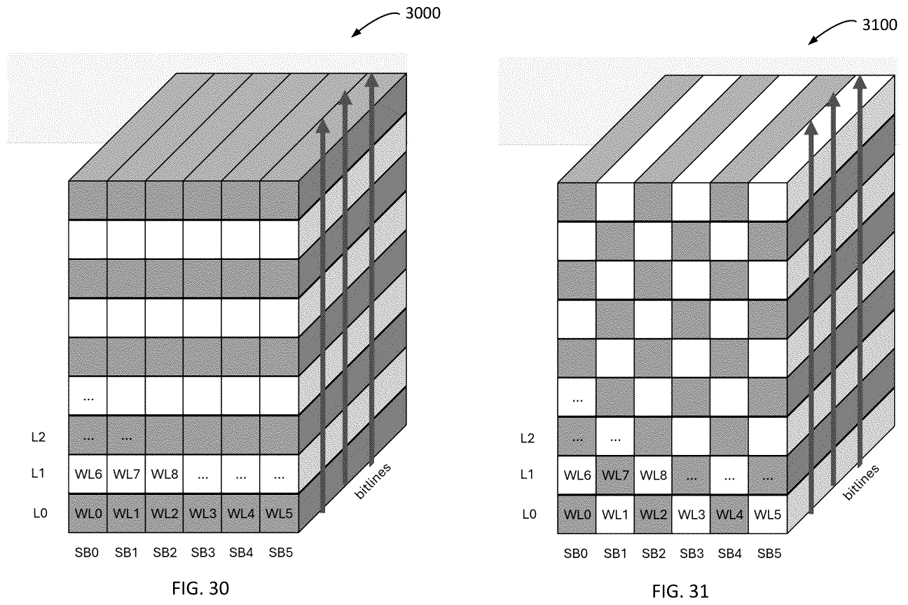

For instance, FIG. 27 is a diagram 2700 illustrating 1-page and 2-page isolations for 2D NAND according to some configurations. As illustrated in FIG. 27, the page isolation for 2D NAND may include isolating WL which are orthogonal to the BL, where cells are on the same BL are more dependent to each other. For 3D, this translates to isolating the Layer, which are orthogonal to the BLs, as illustrated in FIG. 28. FIG. 28 is a diagram 2800 illustrating no page isolation for 3D NAND according to some configurations. FIG. 29 is a diagram 2900 illustrating isolating sub-blocks (1-sub-block isolation) according to some configurations. FIG. 30 is a diagram 3000 illustrating isolating 1-Layer-Neighbor according to some configurations. As illustrated in FIG. 30, the isolated Layers are orthogonal to the BLs. Additionally, FIG. 30 illustrates at least 1-Page distance on z-axis (Layer-axis).

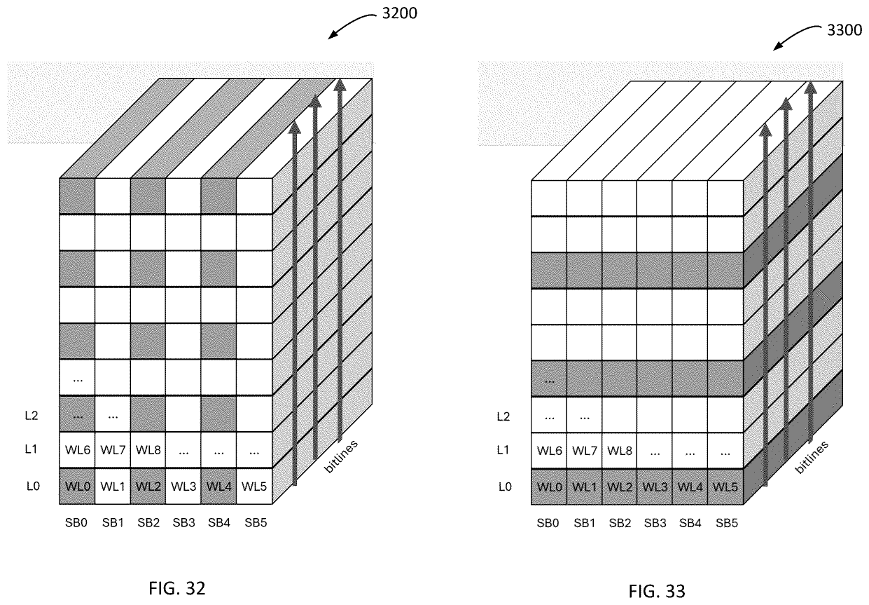

FIG. 31 is a diagram 3100 illustrating isolating 1-Layer-Neighbor and 1-SubBlock-Neighbor according to some configurations. FIG. 31 illustrates at least 1-Page distance on z-axis (Layer-axis). FIG. 32 is a diagram 3200 illustrating isolating 1-Layer-Neighbor, 1-SubBlock-Neighbor and 1-Diagonal-Neighbor according to some configurations. FIG. 32 illustrates at least 1-Page distance on z-axis (Layer-axis).

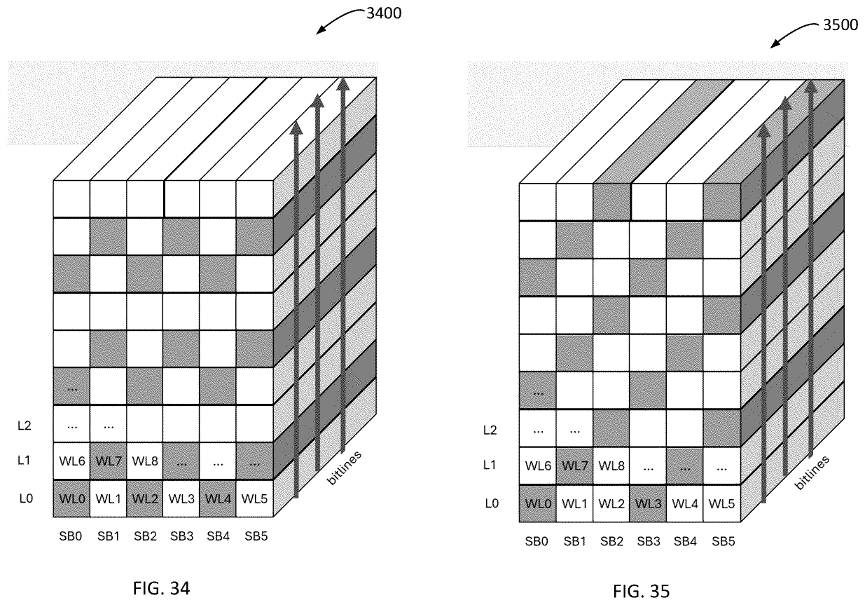

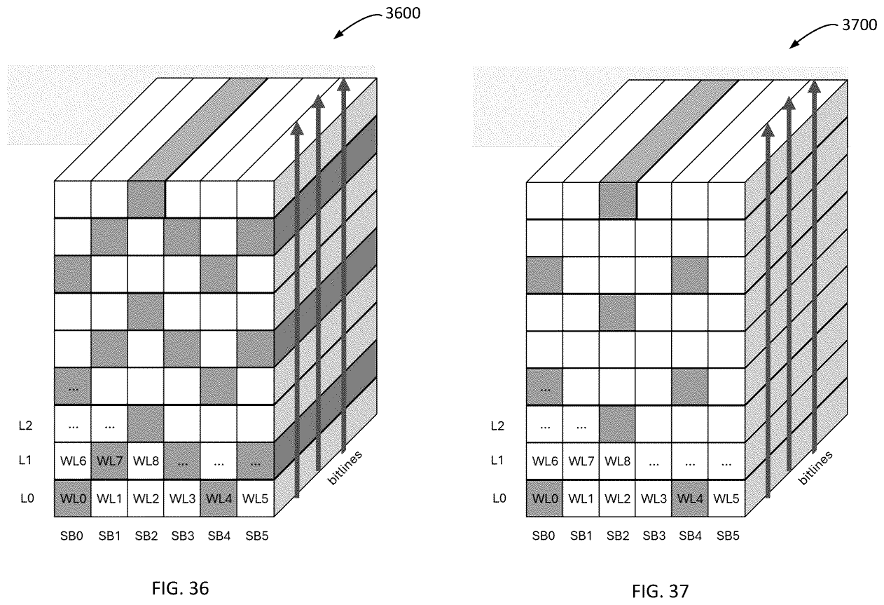

FIG. 33 is a diagram 3300 illustrating 2-layer isolation according to some configurations. FIG. 33 illustrates at least 2-Page distance on z-axis (Layer-axis). FIG. 34 is a diagram 3400 illustrating 2-layer isolation and 1-SubBlock-Neighbor isolation according to some configurations. FIG. 34 illustrates at least 2-Page distance on z-axis (Layer-axis) and at least 1-Page distance on y-axis (SubBlock-axis). FIG. 35 is a diagram 3500 illustrating 2-layer isolation and 2-SubBlock-Neighbor isolation according to some configurations. FIG. 35 illustrates at least 2-Page distance on z-axis (Layer-axis) and at least 2-Page distance on y-axis (SubBlock-axis). FIG. 36 is a diagram 3600 illustrating 2-layer isolation and at least 1-SubBlock-Neighbor isolation according to some configurations. FIG. 36 illustrates at least 2-Page distance on z-axis (Layer-axis). FIG. 37 is a diagram 3700 illustrating 2-layer isolation and at least 2-SubBlock-Neighbor isolation according to some configurations. FIG. 37 illustrates at least 2-Page distance on z-axis (Layer-axis).

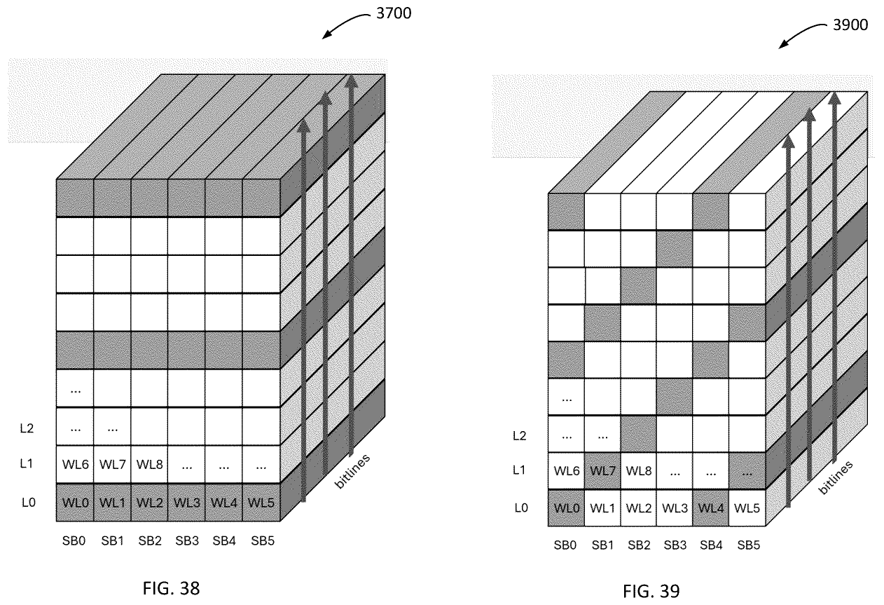

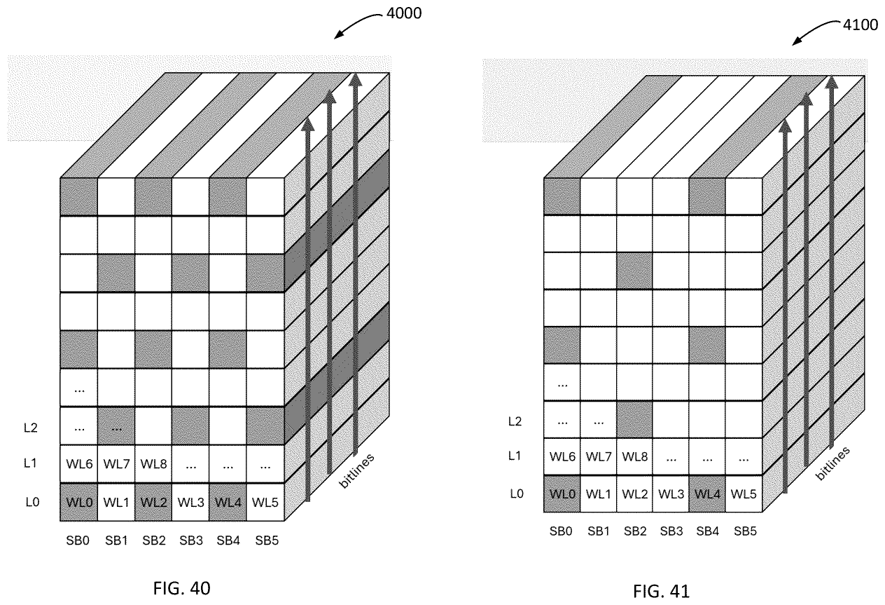

FIG. 38 is a diagram 3800 illustrating 3-layer isolation according to some configurations. FIG. 38 illustrates at least 3-page distance on z-axis (Layer-axis). FIG. 39 is a diagram 3900 illustrating 3-layer isolation according to some configurations. FIG. 39 illustrates at least 3-page distance on z-axis (Layer-axis). FIG. 40 is a diagram 4000 illustrating 3-layer isolation according to some configurations. FIG. 40 illustrates at least 3-page distance on z-axis (Layer-axis). FIG. 41 is a diagram 4100 illustrating 3-layer isolation according to some configurations.

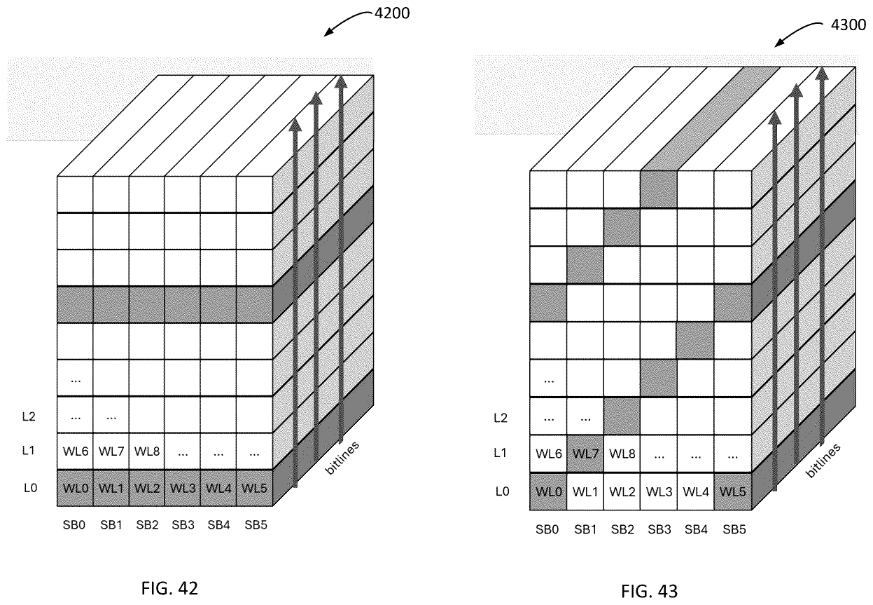

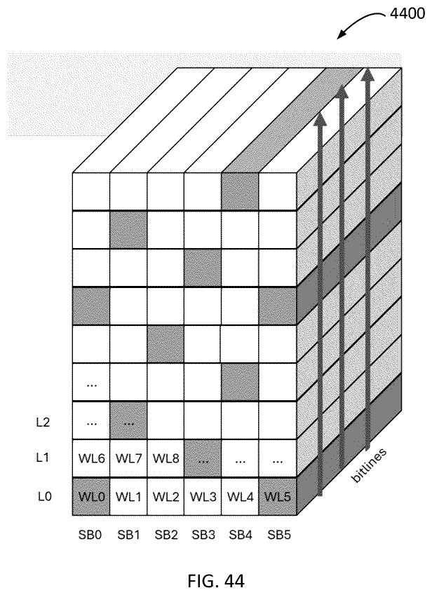

FIG. 42 is a diagram 4200 illustrating 4-layer isolation according to some configurations. FIG. 42 illustrates at least 4-page distance on z-axis (Layer-axis). FIG. 43 is a diagram 4300 illustrating 4-layer isolation according to some configurations. FIG. 44 is a diagram 4400 illustrating 4-layer isolation according to some configurations. FIG. 44 illustrates at least 4-Page distance on z-axis (Layer-axis).

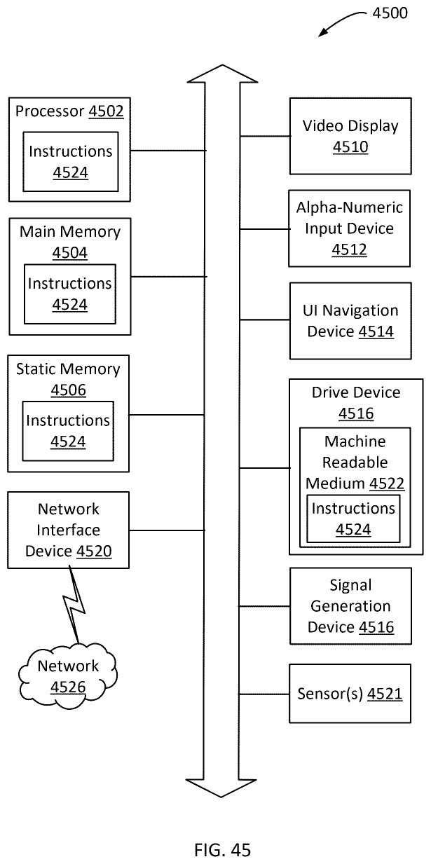

FIG. 45 is a block diagram illustrating an example of a machine upon which one or more aspects of embodiments of the present technology can be implemented.

Referring to FIG. 45, an aspect of an embodiment of the present technology includes, but not limited thereto, a system, a method, or a non-transitory computer readable medium that provides one or more of the following: a) second chance for end-of-life flash memory blocks via page isolation, b) page isolation technique for extended endurance of flash memory blocks, and c) extending the lifespan of aged flash memory blocks through page isolation, which illustrates a block diagram of an example machine 4500 upon which one or more embodiments (e.g., discussed methodologies) can be implemented (e.g., run).

Examples of the machine 4500 can include logic, one or more components, circuits (e.g., modules), or mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) can be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit can be implemented mechanically or electronically. For example, a circuit can comprise dedicated circuitry or logic that is specifically configured to perform one or more techniques such as discussed above, such as including a special-purpose processor, a field programmable gate array (FPGA) or an application-specific integrated circuit (ASIC). In an example, a circuit can comprise programmable logic (e.g., circuitry, as encompassed within a general-purpose processor or other programmable processor) that can be temporarily configured (e.g., by software) to perform the certain operations. It will be appreciated that the decision to implement a circuit mechanically (e.g., in dedicated and permanently configured circuitry), or in temporarily configured circuitry (e.g., configured by software) can be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor can be configured as respective different circuits at different times. Software can accordingly configure a processor, for example, to constitute a particular circuit at one instance of time and to constitute a different circuit at a different instance of time.

In an example, circuits can provide information to, and receive information from, other circuits. In this example, the circuits can be regarded as being communicatively coupled to one or more other circuits. Where multiple of such circuits exist contemporaneously, communications can be achieved through signal transmission (e.g., over appropriate circuits and buses) that connect the circuits. In embodiments in which multiple circuits are configured or instantiated at different times, communications between such circuits can be achieved, for example, through the storage and retrieval of information in memory structures to which the multiple circuits have access. For example, one circuit can perform an operation and store the output of that operation in a memory device to which it is communicatively coupled. A further circuit can then, at a later time, access the memory device to retrieve and process the stored output. In an example, circuits can be configured to initiate or receive communications with input or output devices and can operate on a resource (e.g., a collection of information).

The various operations of method examples described herein can be performed, at least partially, by one or more processors that are temporarily configured (e.g., by software) or permanently configured to perform the relevant operations. Whether temporarily or permanently configured, such processors can constitute processor-implemented circuits that operate to perform one or more operations or functions. In an example, the circuits referred to herein can comprise processor-implemented circuits.

Similarly, the methods described herein can be at least partially processor-implemented. For example, at least some of the operations of a method can be performed by one or processors or processor-implemented circuits. The performance of certain of the operations can be distributed among the one or more processors, not only residing within a single machine, but deployed across a number of machines. In an example, the processor or processors can be located in a single location (e.g., within a home environment, an office environment or as a server farm), while in other examples the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) can be implemented in digital electronic circuitry, in computer hardware, in firmware, in software, or in any combination thereof Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computer or on multiple computers at one site or distributed across multiple sites and interconnected by a communication network.

In an example, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 4500) and software architecture that can be deployed in example embodiments.

In an example, the machine 4500 can operate as a standalone device or the machine 4500 can be connected (e.g., networked) to other machines.

In a networked deployment, the machine 4500 can operate in the capacity of cither a server or a client machine in server-client network environments. In an example, machine 4500 can act as a peer machine in peer-to-peer (or other distributed) network environments. The machine 4500 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 4500. Further, while only a single machine 4500 is illustrated, the term “machine” shall also be taken to include any collection of machines that individually or jointly execute a set (or multiple sets) of instructions to perform any one or more of the methodologies discussed herein.

Example machine (e.g., computer system) 4500 can include a processor 4502 (e.g., a central processing unit (CPU), a graphics processing unit (GPU) or both), a main memory 4504 and a static memory 4506, some or all of which can communicate with each other via a bus 4508. The machine 4500 can further include a display unit 4510, an alphanumeric input device 4512 (e.g., a keyboard), and a user interface (UI) navigation device 4514 (e.g., a mouse). In an example, the display unit 4510, input device 4512 and UI navigation device 4514 can be a touch screen display. The machine 4500 can additionally include a storage device (e.g., drive unit) 4516, a signal generation device 4518 (e.g., a speaker), a network interface device 4520, and one or more sensors 4521, such as a global positioning system (GPS) sensor, compass, accelerometer, or other sensor.

The storage device 4516 can include a machine readable medium 4522 on which is stored one or more sets of data structures or instructions 4524 (e.g., software) embodying or utilized by any one or more of the methodologies or functions described herein. The instructions 4524 can also reside, completely or at least partially, within the main memory 4504, within static memory 4506, or within the processor 4502 during execution thereof by the machine 4500. In an example, one or any combination of the processor 4502, the main memory 4504, the static memory 4506, or the storage device 4516 can constitute machine readable media.

While the machine readable medium 4522 is illustrated as a single medium, the term “machine readable medium” can include a single medium or multiple media (e.g., a centralized or distributed database, and/or associated caches and servers) that configured to store the one or more instructions 4524. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media.

Specific examples of machine readable media can include non-volatile memory, including, by way of example, semiconductor memory devices (e.g., Electrically Programmable Read-Only Memory (EPRONI), Electrically Erasable Programmable Read-Only Memory (EEPROM)) and flash memory devices; magnetic disks such as internal hard disks and removable disks; magneto-optical disks; and CD-RONI and DVD-RONI disks.

The instructions 4524 can further be transmitted or received over a communications network 4526 using a transmission medium via the network interface device 4520 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

Accordingly, an aspect of an embodiment of the present disclosure provides a system, a method, and a non-transitory computer-readable medium for, among other things, one or more of the following: a) second chance for end-of-life flash memory blocks via page isolation, b) page isolation technique for extended endurance of flash memory blocks, or c) extending the lifespan of aged flash memory blocks through page isolation.

An aspect of an embodiment of the present disclosure provides a system, method and non-transitory computer-readable medium for, among other things, extending the lifespan of aged flash memory blocks through page isolation, significantly increasing endurance by isolating aged pages to mitigate cell-to-cell interference without adding computational complexity. The system, method, and non-transitory computer-readable medium enhances flash memory reliability and reduces wastage.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device nonfunctional.

Likewise, any step described with reference to a particular method or process may be integrated, incorporated, or otherwise combined with other methods or processes described herein unless specifically stated otherwise or if it should render the embodiment method nonfunctional.

Furthermore, multiple embodiment devices or embodiment methods may be combined, incorporated, or otherwise integrated into one another to construct or develop further embodiments of the technology described herein.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/operator/customer/client or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure.

Similarly, it is also to be understood that the mention of one or more components in a device or system does not preclude the presence of additional components or intervening components between those components expressly identified.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1-1.5, 1.5-2, 2-2.75, 2.75-3, 3-3.9, 3.9-4, 4-4.24, 4.24-5, 2-5, 3-5, 1-4, and 2-4). It is also to be understood that all numbers and fractions thereof are presumed to be modified by the term “about.”

Additional descriptions of aspects of the present disclosure will now be provided with reference to the accompanying drawings. The drawings form a part hereof and show, by way of illustration, specific embodiments or examples.

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system, comprising:
an electronic processor configured to:
determine that a memory block of a set of memory blocks has achieved an end-of-life state, wherein the memory block includes a plurality of pages; and
responsive to the memory block achieving the end-of-life state, execute page isolation with respect to the plurality of pages in order to increase lifetime of at least a subset of the plurality of pages.

2. The system of claim 1, wherein the page isolation is a 1-page isolation that involves programming every other page of the plurality of pages included in the memory block.

3. The system of claim 2, wherein execution of the 1-page isolation results in increased lifetime for approximately 50% of the plurality of pages of the memory block.

4. The system of claim 1, wherein the page isolation is a 2-page isolation that involves programming every second page of the plurality of pages included in the memory block.

5. The system of claim 1, wherein the page isolation is a 3-page isolation that involves programming every third page of the plurality of pages included in the memory block.

6. The system of claim 1, wherein execution of the page isolation prevents capacity loss.

7. The system of claim 1, wherein the set of memory blocks are a set of flash memory blocks.

8. A method for page isolation for memory blocks, comprising:
determining, with an electronic processor, that a memory block of a set of memory blocks has achieved an end-of-life state, wherein the memory block includes a plurality of pages; and
responsive to the memory block achieving the end-of-life state, executing, with the electronic processor, page isolation with respect to the plurality of pages in order to increase lifetime of at least a subset of the plurality of pages.

9. The method of claim 8, wherein executing, with the electronic processor, the page isolation includes executing 1-page isolation by isolating every other page of the plurality of pages included in the memory block.

10. The method of claim 9, further comprising:
upon detection of a first error threshold, executing, with the electronic processor, 2-page isolation by isolating every second page of the plurality of pages included in the memory block.

11. The method of claim 10, further comprising:
upon detection of a second error threshold, executing, with the electronic processor, 3-page isolation by isolating every third page of the plurality of pages included in the memory block.

12. The method of claim 8, wherein executing, with the electronic processor, the page isolation includes executing 1-page isolation by isolating every other page of the plurality of pages included in the memory block.

13. The method of claim 8, wherein executing, with the electronic processor, the page isolation includes executing 2-page isolation by isolating every second page of the plurality of pages included in the memory block.

14. The method of claim 13, wherein executing the 2-page isolation includes executing the 2-page isolation after executing 1-page isolation by isolating every other page of the plurality of pages included in the memory block.

15. The method of claim 8, wherein executing, with the electronic processor, the page isolation includes executing 3-page isolation by isolating every third page of the plurality of pages included in the memory block.

16. The method of claim 8, further comprising:
receiving, with the electronic processor, a firmware update related to the page isolation; and
storing, with the electronic processor, the firmware update related to the page isolation.

17. The method of claim 16, wherein executing, with the electronic processor, the page isolation includes executing, with the electronic processor, the firmware update.

18. A non-transitory computer-readable storage medium storing instructions that, when executed by a processor, cause the processor to perform a method of page isolation, the method comprising:
determining that a memory block of a set of memory blocks has achieved an end-of-life state, wherein the memory block includes a plurality of pages; and
responsive to the memory block achieving the end-of-life state, executing page isolation with respect to the plurality of pages in order to increase lifetime of at least a subset of the plurality of pages.

19. The computer-readable medium of claim 18, wherein executing the page isolation includes isolating every other page of the plurality of pages included in the memory block.

20. The computer-readable medium of claim 18, wherein executing the page isolation includes isolating (i) every second page of the plurality of pages included in the memory block; or (ii) every third page of the plurality of pages included in the memory block.
